(19) United States
(12) Patent Application Publication
(10) Pub. No.: US 2026/0113377 A1
(43) Pub. Date: Apr. 23, 2026

(54) EXTENDED REALITY PERCEPTION INFORMATION SHARING

(71) Applicant: QUALCOMM Incorporated, San Diego, CA (US)

(72) Inventors: Hussein METWALY SAAD, Poway, CA (US); Peerapol TINNAKORNSRISUPHAP, San Diego, CA (US); Simone MERLIN, San Diego, CA (US); Belal Salama Amin KORANY, San Diego, CA (US); Sanghamitra BHATTACHARYA, San Diego, CA (US); Yann LEBRUN, Velizy-Villacoublay (FR); Andres Oscar ALTIERI, Bures-sur-Yvette (FR); Prashanth Haridas HANDE, San Diego, CA (US); Cristina DOBRIN, San Diego, CA (US); Abhijeet BISAIN, San Diego, CA (US)

(21) Appl. No.: 18/922,828

(22) Filed: Oct. 22, 2024

(51) Int. Cl. H04L 67/131; H04W 4/38

(52) U.S. Cl. CPC H04L 67/131; H04W 4/38

(57) ABSTRACT

Various aspects of the present disclosure generally relate to wireless communication. In some aspects, a first device may perform an initial setup process between the first device and a second device. The first device may transmit, to at least one of the second device or a server that communicates with the first device and the second device, one or more first perception information inputs associated with the first device. The first device may receive, from at least one of the second device or the server, one or more perception information outputs, combined perception information that is based at least in part on the one or more first perception information inputs and on one or more second perception information inputs associated with the second device. Numerous other aspects are described.

### FIELD OF THE DISCLOSURE

Aspects of the present disclosure generally relate to wireless communication and specifically relate to techniques, apparatuses, and methods associated with extended reality perception information sharing.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a first device. The method may include performing an initial setup process between the first device and a second device, wherein the initial setup process indicates that the first device and the second device are to share perception information associated with an extended reality application. The method may include transmitting, to at least one of the second device or a server that communicates with the first device and the second device, one or more first perception information inputs associated with the first device. The method may include receiving, from at least one of the second device or the server, one or more perception information outputs, wherein the one or more perception information outputs include combined perception information that is based at least in part on the one or more first perception information inputs and on one or more second perception information inputs associated with the second device.

Some aspects described herein relate to a method of wireless communication performed by a server. The method may include receiving, from a first device, one or more first perception information inputs associated with a first extended reality application operating on the first device. The method may include receiving, from a second device, one or more second perception information inputs associated with a second extended reality application operating on the second device. The method may include generating combined perception information that is based at least in part on the one or more first perception information inputs and the one or more second perception information inputs. The method may include transmitting, to at least one of the first device or the second device, the combined perception information.

Some aspects described herein relate to an apparatus for wireless communication at a first device. The apparatus may include one or more memories and one or more processors coupled to the one or more memories. The one or more processors may be configured to perform an initial setup process between the first device and a second device, wherein the initial setup process indicates that the first device and the second device are to share perception information associated with an extended reality application. The one or more processors may be configured to transmit, to at least one of the second device or a server that communicates with the first device and the second device, one or more first perception information inputs associated with the first device. The one or more processors may be configured to receive, from at least one of the second device or the server, one or more perception information outputs, wherein the one or more perception information outputs include combined perception information that is based at least in part on the one or more first perception information inputs and on one or more second perception information inputs associated with the second device.

Some aspects described herein relate to an apparatus for wireless communication at a server. The apparatus may include one or more memories and one or more processors coupled to the one or more memories. The one or more processors may be configured to receive, from a first device, one or more first perception information inputs associated with a first extended reality application operating on the first device. The one or more processors may be configured to receive, from a second device, one or more second perception information inputs associated with a second extended reality application operating on the second device. The one or more processors may be configured to generate combined perception information that is based at least in part on the one or more first perception information inputs and the one or more second perception information inputs. The one or more processors may be configured to transmit, to at least one of the first device or the second device, the combined perception information.

Some aspects described herein relate to a non-transitory computer-readable medium that stores a set of instructions for wireless communication by a first device. The set of instructions, when executed by one or more processors of the first device, may cause the first device to perform an initial setup process between the first device and a second device, wherein the initial setup process indicates that the first device and the second device are to share perception information associated with an extended reality application. The set of instructions, when executed by one or more processors of the first device, may cause the first device to transmit, to at least one of the second device or a server that communicates with the first device and the second device, one or more first perception information inputs associated with the first device. The set of instructions, when executed by one or more processors of the first device, may cause the first device to receive, from at least one of the second device or the server, one or more perception information outputs, wherein the one or more perception information outputs include combined perception information that is based at least in part on the one or more first perception information inputs and on one or more second perception information inputs associated with the second device.

Some aspects described herein relate to a non-transitory computer-readable medium that stores a set of instructions for wireless communication by a server. The set of instructions, when executed by one or more processors of the server, may cause the server to receive, from a first device, one or more first perception information inputs associated with a first extended reality application operating on the first device. The set of instructions, when executed by one or more processors of the server, may cause the server to receive, from a second device, one or more second perception information inputs associated with a second extended reality application operating on the second device. The set of instructions, when executed by one or more processors of the server, may cause the server to generate combined perception information that is based at least in part on the one or more first perception information inputs and the one or more second perception information inputs. The set of instructions, when executed by one or more processors of the server, may cause the server to transmit, to at least one of the first device or the second device, the combined perception information.

Some aspects described herein relate to an apparatus for wireless communication. The apparatus may include means for performing an initial setup process between the apparatus and a device, wherein the initial setup process indicates that the apparatus and the device are to share perception information associated with an extended reality application. The apparatus may include means for transmitting, to at least one of the device or a server that communicates with the apparatus and the device, one or more first perception information inputs associated with the apparatus. The apparatus may include means for receiving, from at least one of the device or the server, one or more perception information outputs, wherein the one or more perception information outputs include combined perception information that is based at least in part on the one or more first perception information inputs and on one or more second perception information inputs associated with the device.

Some aspects described herein relate to an apparatus for wireless communication. The apparatus may include means for receiving, from a first device, one or more first perception information inputs associated with a first extended reality application operating on the first device. The apparatus may include means for receiving, from a second device, one or more second perception information inputs associated with a second extended reality application operating on the second device. The apparatus may include means for generating combined perception information that is based at least in part on the one or more first perception information inputs and the one or more second perception information inputs. The apparatus may include means for transmitting, to at least one of the first device or the second device, the combined perception information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of devices designed for extended reality traffic applications, in accordance with the present disclosure.

FIG. 4 is a diagram of an example of dynamic distributed split perception, in accordance with the present disclosure.

FIG. 5 is a diagram illustrating an example of extended reality perception information sharing, in accordance with the present disclosure.

FIGS. 6A-6E are diagrams illustrating examples of initial setup processes between a first device and a second device, in accordance with the present disclosure.

FIGS. 7A-7B are diagrams illustrating examples of perception information sharing between a first device and a second device, in accordance with the present disclosure.

FIG. 8 is a diagram illustrating an example of perception information sharing between one or more devices and a server, in accordance with the present disclosure.

FIG. 9 is a diagram illustrating an example of perception information sharing between two or more devices, in accordance with the present disclosure.

FIG. 10 is a diagram illustrating an example process performed, for example, at a first device or an apparatus of a first device, in accordance with the present disclosure.

FIG. 11 is a diagram illustrating an example process performed, for example, at a server or an apparatus of a server, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Extended reality (XR) is a technology that enable users to interact with virtual environments and digitally enhanced real-world surroundings. XR is commonly used in gaming applications, allowing users of the gaming applications to engage in highly interactive and immersive experiences that combine virtual and physical realities. XR devices, such as headsets and smart glasses, among other examples, may rely on cameras, sensors, and other tracking technologies to construct and maintain the virtual environments. Data collected from the cameras and sensors (for example, video cameras and depth sensors) may allow XR devices to map the real-world environment and overlay virtual objects within that environment. For example, an XR headset may use cameras to scan a room and to place a virtual object on a table, allowing a user of the XR device to see and interact with both the physical and digital elements as part of the same experience.

Multiple XR devices may operate in the same environment, such as in the same room, at the same time. Additionally, the multiple XR devices operating in the same environment may be executing the same applications. This may occur, for example, during multiplayer gaming or other collaborative virtual tasks. When operating in the same environment, each XR device may separately generate its own virtual environment in accordance with data collected by the sensors of that device. This can have a number of negative impacts on the XR devices. Requiring each XR device to generate its own virtual environment may result in varying quality between the different XR devices. For example, a device equipped with a higher-resolution camera or more advanced sensors may generate a more detailed and accurate environment compared to a device with lower-grade hardware. This difference in perception can create an inconsistent experience for users, thereby degrading the quality of the interaction. Additionally, generating a virtual environment may require significant power consumption by an XR device. Requiring each XR device to independently generate its own virtual environment, despite multiple XR devices being located in that environment, may be a waste of battery resources at the XR devices. This may particularly impact XR devices having a smaller battery capacity, such as XR glasses. Further, virtual objects or interactions may be out of sync in the different virtual environments created by the different XR devices. This may significantly disrupt the shared user experience.

Various aspects generally relate to wireless communications. Some aspects more specifically relate to extended reality perception information sharing. A first device may perform an initial setup process between the first device and a second device. The first device and the second device may be XR devices. The initial setup process may include the first device determining that the first device and the second device are to share perception information associated with an XR application. The perception information may be any information that can be used by the first device or the second device to generate or maintain a virtual environment. For example, the perception information may indicate one or more characteristics of a physical environment associated with the first device and the second device, one or more objects located in the environment, one or more lighting characteristics of the environment, one or more positioning characteristics of the first device or the second device, or one or more user characteristics associated with one or more users of the first device or the second device, among other examples. The first device, the second device, or a server that communicates with the first device and the second device may be configured to generate combined perception information that is based at least in part on the one or more first perception information inputs associated with the first device and one or more second perception information inputs associated with the second device. In some examples, the server that communicates with the first device and the second device may be configured to generate the combined perception information. In these examples, the server may receive the one or more first perception information inputs associated with the first device, receive the one or more second perception information inputs associated with the second device, generate combined perception information using the one or more first perception inputs and the one or more second perception information inputs, and transmit the combined perception information to the first device and the second device. In some other examples, the first device may be configured to generate the combined perception information. In these examples, the first device may receive the one or more second perception information inputs from the second device, generate combined perception information using the one or more first perception inputs collected by the first device and the one or more second perception information inputs received from the second device, and transmit the combined perception information to the second device. In some other examples, the second device may be configured to generate the combined perception information. In these examples, the first device may transmit the one or more first perception information inputs to the second device, and may receive combined perception information from the second device that is based at least in part on the one or more first perception information inputs and one or more second perception information inputs collected by the second device. The first device and the second device may interact with the XR application using the combined perception information.

Particular aspects of the subject matter described in this disclosure can be implemented to realize one or more of the following potential advantages. In some aspects, by enabling the first device and the second device to share perception information and to use combined perception information, the described techniques can be used to improve perception information quality at the first device and the second device. For example, the combined perception information may enable both the first device and the second device to use perception information collected by a higher-quality sensor or camera that is included in only one of the first device or the second device. In some aspects, by enabling the first device and the second device to share perception information and to use combined perception information, the described techniques can be used to reduce battery consumption by the first device and the second device. For example, the sharing of the perception information may enable the first device to collect information associated with certain features or locations of the shared environment and may enable the second device to collect information associated with other features or locations of the shared environment, which may reduce an amount of perception information to be collected by each of the first device and the second device. In some aspects, by enabling the first device and the second device to share perception information and to use combined perception information, the described techniques can be used to improve synchronization between applications hosted by the first device and the second device. These example advantages, among others, are described in more detail below.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

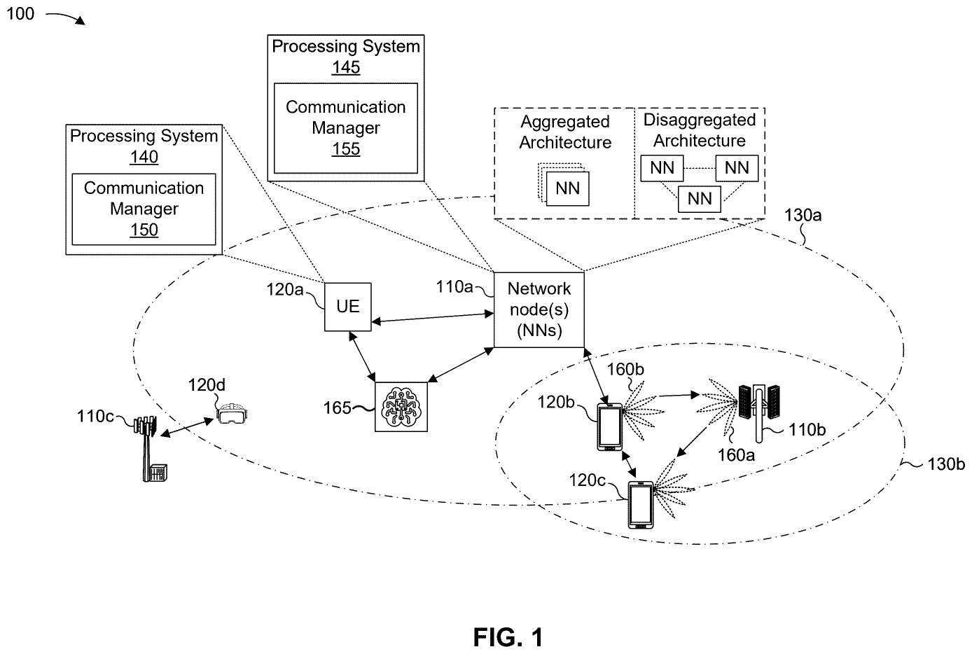

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, and a network node 110c. The network nodes 110 may support communications with multiple UEs 120. For example, in FIG. 1, the network nodes 110 support communication with a UE 120a, a UE 120b, a UE 120c, and a UE 120d. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

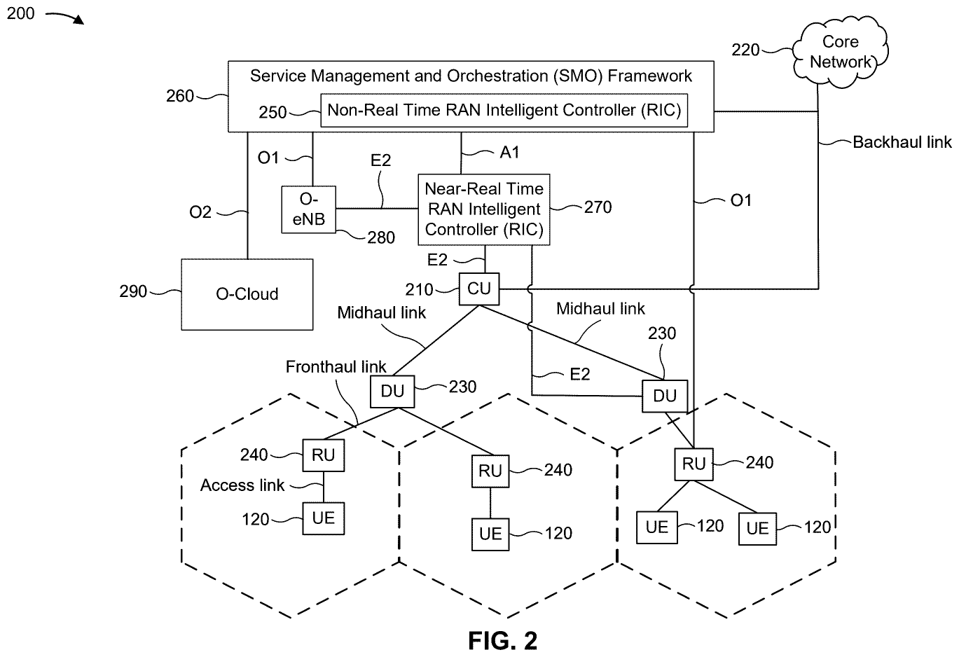

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120, such as the UE 120d, may support one or more XR functionalities. For example, the UE 120d may be an XR device or may be associated with an XR device (for example, the UE 120d may be connected to the XR device, such as via a wired (for example, universal serial bus (USB), or serial advanced technology attachment (SATA)) connection and/or a wireless (for example, Bluetooth, Wi-Fi, 5G) connection). XR functionalities may include augmented reality (AR), virtual reality (VR), or mixed reality (MR), among other examples. For example, when providing an XR service, the UE 120d may provide rendered data via a display (such as a screen), a set of VR goggles, a heads-up display, or another type of display. The XR device may be an AR glasses device, a VR glass device, or other gaming device.

The XR functionalities may be supported by an application server. The application server may host an application, such as a gaming application, a video streaming application, an XR, VR, or AR application, and/or another type of application for which communication flows of streaming data are provided between a UE 120 and the application server, between an XR device and the application server, and/or between the application server and another device in the wireless communication network 100. The application server may be included in an edge server, a cloud environment, and/or another type of server environment. A UE 120 and/or an XR device may execute an application client associated with the application hosted by the application server, such as a gaming application client, a video streaming application client, an XR application client, a VR application client, an AR application client, and/or another type of application client.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the first device may include a communication manager 150. As described in more detail elsewhere herein, the communication manager 150 may perform an initial setup process between the first device and a second device, wherein the initial setup process indicates that the first device and the second device are to share perception information associated with an extended reality application; transmit, to at least one of the second device or a server that communicates with the first device and the second device, one or more first perception information inputs associated with the first device; and receive, from at least one of the second device or the server, one or more perception information outputs, wherein the one or more perception information outputs include combined perception information that is based at least in part on the one or more first perception information inputs and on one or more second perception information inputs associated with the second device. Additionally, or alternatively, the communication manager 150 may perform one or more other operations described herein.

In some aspects, the server may include a communication manager 155. As described in more detail elsewhere herein, the communication manager 155 may receive, from a first device, one or more first perception information inputs associated with a first extended reality application operating on the first device; receive, from a second device, one or more second perception information inputs associated with a second extended reality application operating on the second device; generate combined perception information that is based at least in part on the one or more first perception information inputs and the one or more second perception information inputs; and transmit, to at least one of the first device or the second device, the combined perception information. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

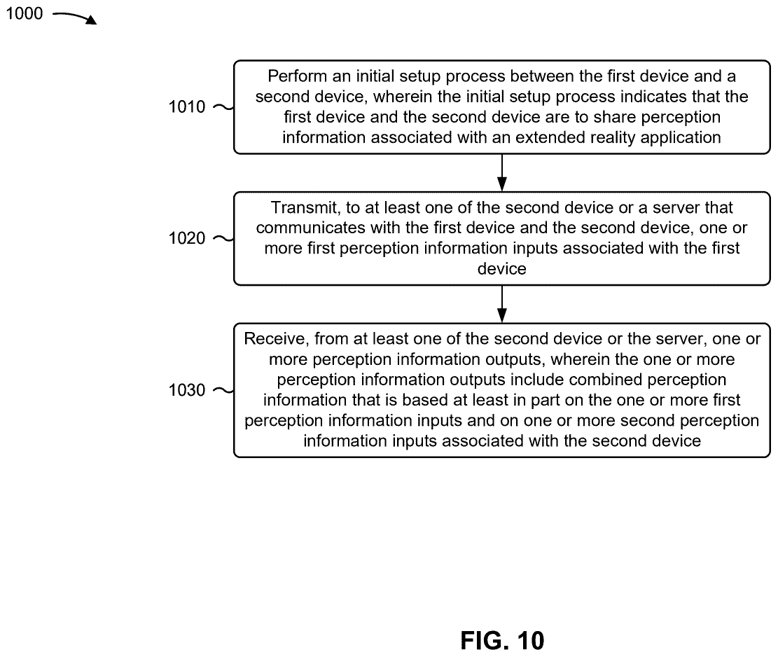

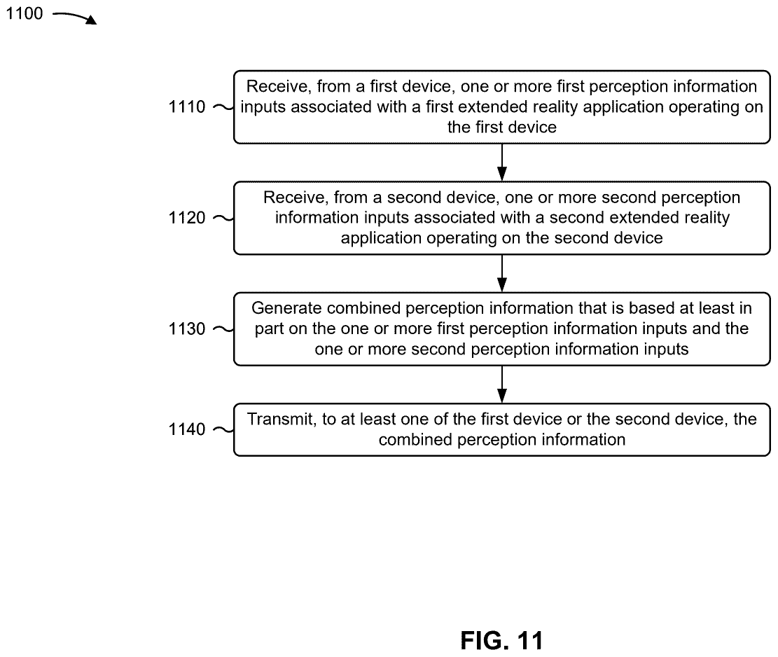

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with extended reality perception information sharing, as described in more detail elsewhere herein. For example, the processing system 145 of the network node 110, the processing system 140 of the UE 120, the CU 210, the DU 230, or the RU 240 may perform or direct operations of, for example, process 1000 of FIG. 10, process 1100 of FIG. 11, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

In some aspects, the first device (for example, UE 120d) includes means for performing an initial setup process between the first device and a second device, wherein the initial setup process indicates that the first device and the second device are to share perception information associated with an extended reality application; means for transmitting, to at least one of the second device or a server that communicates with the first device and the second device, one or more first perception information inputs associated with the first device; and/or means for receiving, from at least one of the second device or the server, one or more perception information outputs, wherein the one or more perception information outputs include combined perception information that is based at least in part on the one or more first perception information inputs and on one or more second perception information inputs associated with the second device. In some aspects, the means for the first device (for example, UE 120d) to perform operations described herein may include, for example, one or more of communication manager 150, processing system 140, a radio, one or more RF chains, one or more transceivers, one or more antennas, one or more modems, a reception component, and/or a transmission component, among other examples.

In some aspects, the server (for example, network node 110c) includes means for receiving, from a first device, one or more first perception information inputs associated with a first extended reality application operating on the first device; means for receiving, from a second device, one or more second perception information inputs associated with a second extended reality application operating on the second device; means for generating combined perception information that is based at least in part on the one or more first perception information inputs and the one or more second perception information inputs; and/or means for transmitting, to at least one of the first device or the second device, the combined perception information. In some aspects, the means for the server (for example, network node 110c) to perform operations described herein may include, for example, one or more of communication manager 155, processing system 145, a radio, one or more RF chains, one or more transceivers, one or more antennas, one or more modems, a reception component, and/or a transmission component, among other examples.

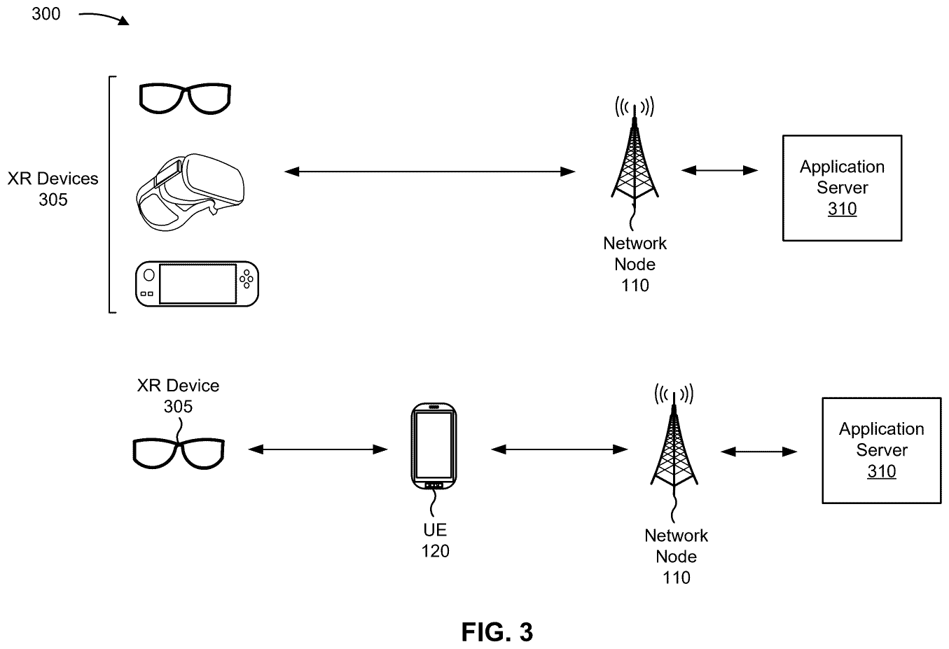

FIG. 3 is a diagram illustrating an example 300 of devices designed for extended reality traffic applications, in accordance with the present disclosure. As shown in FIG. 3, an XR device 305 may communicate with an application server 310.

In some cases, the XR device 305 may communicate with the application server 310 through a UE 120 that communicates with a network node 110 in a wireless communication network (e.g., wireless communication network 100). Here, the UE 120 may be communicatively connected with the XR device 305 by a wired (e.g., universal serial bus (USB), serial ATA (SATA)) and/or a wireless (e.g., Bluetooth, Wi-Fi, 5G) connection.

In some cases, the XR device 305 communicates with the application server 310 without the use of an intermediate UE 120. Here, the XR device 305 communicates wirelessly with a network node 110 in the wireless network 100 to communicate with the application server 310.

As indicated above, an application server 310 may host an application (e.g., an XR application or an application that has XR support). A UE 120 or an XR device 305 may execute an application client that communicates with the application hosted by the application server 310. Applications for an XR device 305 (or for another type of gaming device such as a UE 120) may include a video game (e.g., where multimedia traffic is transferred to and from the application server 310 at a particular frame rate to support audio and/or video rendering) and/or a VR environment (e.g., where multimedia traffic is transferred to and from the application server 310 at a particular polling rate to support sensor input (e.g., 6 degrees of freedom (6DOF) sensor input and feedback), among other examples. Some applications, including applications for XR, VR, AR, and/or gaming, may require low-latency traffic to and from an edge server or a cloud environment. The traffic to and from the edge server or the cloud environment may be periodic, to support a particular frame rate (e.g., 120 frames per second (FPS), 90 FPS, 60 FPS), a particular refresh rate (e.g., 500 Hertz (Hz), 120 Hz), and/or a particular data transfer rate (e.g., 8 megabits per second (Mbps), 30 Mbps, 45 Mbps) for XR traffic applications.

In some cases, the XR device 305 may be configured with a visual positioning system (VPS). A VPS provides a shared spatial reference framework that enables multiple devices to interact with the same virtual objects in a consistent, real-world context. The VPS may leverage sensor data from device components, such as cameras and depth sensors, to create detailed 3D maps of environments. During a mapping phase, the sensors may gather information regarding the surroundings, which may be processed by the VPS to generate a digital map. In a subsequent relocation phase, the VPS may determine the exact position and orientation of each device within the mapped environment by comparing the live sensor data to a pre-existing map. In XR applications, such as AR or VR applications, the VPS may allow for precise positioning and orientation, enabling virtual content to be accurately anchored to real-world objects or locations. This may be useful in scenarios where multiple devices are to interact with the same digital elements from different perspectives. For example, in indoor environments such as shopping malls or hotel rooms, a VPS can achieve positioning accuracy within centimeters, allowing seamless, immersive experiences that maintain alignment between virtual and physical spaces, regardless of device movements.

As indicated above, FIG. 3 is provided as an example. Other examples may differ from what is described with regard to FIG. 3.

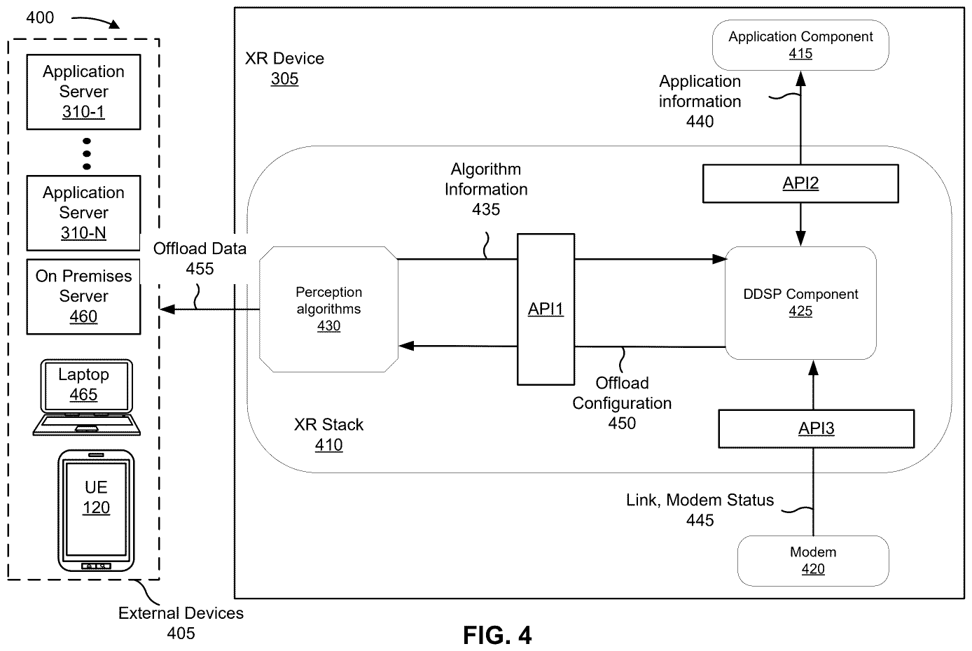

FIG. 4 is a diagram of an example 400 of dynamic distributed split perception, in accordance with the present disclosure. The example 400 of dynamic distributed split perception may include an XR device 305 and group of external devices 405.

The XR device 305 may include an XR stack 410, an application component 415, and a modem 420, among other examples. In some cases, a dynamic distributed split perception (DDSP) component 425 and a perception algorithms component 430 may be configured within the XR stack 410 (e.g., rather than in the application component 415). In some cases, including the DDSP component 425 may simplify implementation of the DDSP component 425 relative to the DDSP component 425 being configured within the application component 415. For example, as described in greater detail below, information utilized by the DDSP component 425 to determine a compute location for perception data may be provided by the perception algorithms component 430, which is also configured within the XR stack 410.

In some cases, the XR stack 410 may include one or more application programming interfaces (APIs) configured to enable the communication of information between the DDSP component 425 and other components of the XR device 305. For example, the XR stack 410 may include a first API (e.g., API1) between the DDSP component 425 and the perception algorithms component 430, a second API (e.g., API2) between the DDSP component 425 and the application component 415, and a third API (e.g., API3) between the DDSP component 425 and the modem 420.

As shown by reference number 435, the perception algorithms component 430 may provide algorithm information to the DDSP component 425. For example, the perception algorithms component 430 may provide algorithm information to the DDSP component 425 via the first API.

In some cases, the algorithm information may include information associated with performing one or more tasks using a perception algorithm. In some cases, the algorithm information may indicate one or more tasks for which the DDSP component 425 is to determine a compute location. For example, the algorithm information may indicate a task associated with depth maps, 3D rendering, and/or semantic segmentation, among other examples. In some cases, the algorithm information may comprise a primary input for initiating the DDSP component 425 to determine a compute location.

In some cases, the algorithm information may indicate a tasks dependency graph associated with the one or more tasks. In some cases, the tasks dependency graph may indicate a dependency relationship between separate tasks. For example, the tasks dependency graph may indicate that a 3D rendering computation utilizes (e.g., depends on) an output of one or more depth maps and/or a semantic segmentation computation.

In some cases, the XR compute location for a particular task may be based at least in part on the tasks dependency graph. For example, in cases where the tasks dependency graph indicates that the 3D rendering computation depends on an output of one or more depth maps and/or a semantic segmentation computation, the DDSP component 425 may determine a same XR compute location for the 3D rendering, the one or more depth maps, and/or the semantic segmentation computation

In some cases, the algorithm information indicates a load of an input and an output (e.g., in megabytes per second (Mbps) and a rate at which data is to be rendered (e.g., in frames per second). For example, the algorithm information may indicate that offloading depth maps requires 12 Mbps on an uplink channel receiving an output requires 10 Mbps on a downlink channel. In some cases, the DDSP component 425 utilizes the load of the input and the output to determine the required throughput and/or an amount of power utilized for communicating a task to an external device 405 and receiving an output from the external device 405.

In some cases, the algorithm information may indicate a local compute power associated with performing the task locally (e.g., on the XR device 305). For example, the algorithm information may indicate that running depth maps locally may consume 610 milliwatts (mW) of power. In some cases, the DDSP component 425 may determine an amount of power that can be conserved by the XR device 305 by offloading a task based at least in part on the local compute power associated with performing the task locally.

In some cases, the algorithm information may indicate a maximum tolerated round trip time (RTT) associated with offloading a task to an external device. For example, the algorithm information may indicate that depths maps may need to be generated every 200 milliseconds (msec).

In some cases, the DDSP component 425 may determine an XR compute location for a task based at least in part on the maximum tolerated RTT. In some cases, the DDSP component 425 may perform a discovery process to identify a set of application servers 310 (e.g., shown as application servers 310-1 through 310-N) and/or to obtain capability information for the set of application servers 310.

In some cases, the capability information may indicate an address (e.g., an IP address, a MAC address) associated with each application server 310, a set of available services available on each application server 310, a compute power of each application server 310, a load of each application server 310, and/or an amount of available power associated with the each application server 310. In some cases, the DDSP component 425 may identify an application server 310 associated with associated with characteristics that indicate that offloading the task to the application server 310 will not result in a violation of the maximum tolerated RTT.

In some cases, the algorithm information may indicate a required computation complexity associated with a task. For example, the algorithm information may indicate a quantity of processing cores required to perform the task, a type of graphics processing unit (GPU) required to perform the task, and/or an amount of available memory required to perform the task, among other examples. The DDSP component 425 may determine the XR compute location based at least in part on identify a device (e.g., an external device 405, the XR device 305) that satisfies the required computation complexity requirements.

In some cases, the algorithm information may indicate one or more privacy requirements. For example, the algorithm information may indicate that a task is associated with a perception algorithm that utilizes sensitive user information as an input.

In some cases, the DDSP component 425 may determine the XR compute location based at least in part on the privacy requirements. For example, the XR compute location as the XR device 305 and/or an external device that is located at a premises of a user associated with the privacy requirements and/or owned by the user (e.g., on premises server 460, laptop 465, and/or UE 120).

In some cases, the DDSP component 425 may determine whether additional processing is to be performed on the perception data based at least in part on the privacy requirements. For example, the DDSP component 425 may determine that sensitive user data is to be removed, obscured, and/or replaced with non-sensitive data prior to the task being offloaded to an external device.

As shown by reference number 440, the DDSP component 425 and the application component 415 may communicate application information. For example, the DDSP component 425 and the application component 415 may communicate application information via the second API.

In some cases, the application information may indicate an available resource for performing a task. For example, the DDSP component 425 may transmit application information indicating that a particular perception algorithm is available, and/or that a particular external device is available to perform a task using the particular perception algorithm, among other examples.

As an example, the DDSP component 425 may transmit application information indicating that depth maps with a resolution of 1024×1024 at 30 fps are available. In some cases, the application component may modify one or more parameters of the XR application based at least in part on the application information.

In some cases, the application information transmitted by the application component 415 and to the DDSP component 425 may indicate a perception algorithm and/or task needed by the application component 415. For example, the application information transmitted by the application component 415 and to the DDSP component 425 may indicate that the application component needs depth maps, a 3D rendering, and/or semantic segmentation, among other examples.

In some cases, the DDSP component 425 may utilize the application information transmitted by the application component 415 to determine an XR compute location for a task. For example, the DDSP component 425 may determine that a task indicated in the application can be performed locally, can be offloaded to an external device 405, and/or can only be performed by a particular external device 405.

In some cases, the application information transmitted by the application component 415 and to the DDSP component 425 may indicate a preferred external device to be used to perform a task. For example, the XR application may be configured with a pre-defined application server that is to be used to perform a task. The application component 415 may transmit application information indicating the pre-defined application server, the task, and/or that the pre-defined application server is to be used to perform the task to the DDSP component 425.

In some cases, the DDSP component 425 may determine an XR compute location for the task based at least in part on the application information. For example, the DDSP component 425 may determine that the task is to be offloaded to the pre-defined application server.

In some cases, the DDSP component 425 may determine the XR compute location for a task based at least in part on information received from the modem 420. As shown by reference number 445, the modem 420 may transmit link and/or modem status information to the DDSP component 425. For example, the modem 420 may transmit link and/or modem status information to the DDSP component 425 via the third API.

In some cases, the link status information may indicate a status and/or a characteristic associated with a communication link used to offload a task to an external device 405. For example, the link status information may indicate whether the communication link is currently operational, a type of network associated with the communication link (e.g., a Wi-Fi network, a cellular network, and/or the like), a capacity of the communication link, an MCS associated with communicating data via the communication link, and/or a number of layers available for communicating data via the communication link, among other examples.

In some cases, the modem status information may indicate a status of the modem 420. For example, the modem status information may indicate a power saving feature associated with the modem 420, background running tasks, and/or an amount of data currently stored in a queue of the modem 420, among other examples.

In some cases, the DDSP component 425 may utilize the modem status information to determine whether the communication link can support a required rate associated with offloading a task and/or a power consumption of the modem 420 while offloading the task.

In some cases, the DDSP component 425 may determine an XR compute location for performing a task based at least in part on the algorithm information, the application information, the link and modem status information, and characteristics of one or more external devices 405 (e.g., characteristics of one or more application servers 310 obtained as a result of performing a discovery process). As described above, determining an XR compute location for XR data refers to determining or selecting the device that is to perform the XR compute of the XR data. Thus, if the DDSP component 425 determines the XR compute location is to be the XR device 305, the DDSP component 425 determines that the XR device 305 is to perform the XR compute of the XR data for the XR device 305. This is referred to as local compute or performing a task locally.

Alternatively, if the DDSP component 425 determines the XR compute location to be an external device 405, the DDSP component 425 determines that the external device 405 is to perform the XR compute of the XR data for the XR device 305. This is referred to as remote compute or offloading the task to an external device.

The DDSP component 425 may determine the XR compute location based at least in part on radio conditions between the XR device 305 and the external device 405, based at least in part on power consumption of the XR device 305, based at least in part on a radio condition prediction associated with the XR device 305, and/or based at least in part on another parameter.

The radio conditions between the UE 120 and a network node 110 may correspond to (or may be indicated by) one or more wireless radio parameters associated with the wireless radio link (e.g., the uplink and/or the downlink) between the UE 120 and the network node 110. The one or more wireless radio parameters may include an RSRP on the uplink and/or on the downlink, an RSSI on the uplink and/or on the downlink, an RSRQ on the uplink and/or on the downlink, and/or a CQI on the uplink and/or on the downlink, and/or an enhanced link capacity estimate (eLCE), among other examples. The wireless radio parameters may be based at least in part on input from a modem of the UE 120 and/or based at least in part on another component of the UE 120.

In some cases, the DDSP component 425 may determine the XR compute location based at least in part on whether a wireless radio parameter satisfies a threshold. For example, the DDSP component 425 may determine the XR compute location to be the application server 310 if an RSRP satisfies (e.g., exceeds, is equal to) an RSRP threshold. As another example, the DDSP component 425 may determine the XR compute location to be the XR device 305 if the RSRP does not satisfy (e.g., is less than, is equal to) the RSRP threshold.

As another example, the DDSP component 425 may determine the XR compute location to be the application server 310 if an eLCE satisfies (e.g., exceeds, is equal to) an eLCE threshold. As another example, the DDSP component 425 may determine the XR compute location to be the XR device 305 if the eLCE does not satisfy (e.g., is less than, is equal to) the eLCE threshold.

The eLCE may refer to an estimated available capacity on the wireless radio link used to communicate data between the DDSP component 425 and an external device 405. The eLCE threshold may be based at least in part on a required bit rate for the application hosted by the application server 310 and the associated application client on the XR device 305. For example, the DDSP component 425 may determine the eLCE threshold to be based at least in part on an approximately 8 Mbps bitrate for a cloud gaming application. As another example, the DDSP component 425 may determine the eLCE threshold to be based at least in part on an approximately 30 Mbps bitrate for an AR application. As another example, the DDSP component 425 may determine the eLCE threshold to be based at least in part on an approximately 45 Mbps bitrate for a VR application.

The power consumption of the XR device 305 may include an estimated power consumption of the XR device 305 for different XR compute locations. As an example, the DDSP component 425 may determine a first estimated power consumption (P_local) of the XR device 305 if the XR compute location were the XR device 305 (e.g., if the XR device 305 were to perform the XR compute for the XR device 305) and a second estimated power consumption (P_remote) of the XR device 305 if the XR compute location is an external device 405 (e.g., if the external device 405 were to perform the XR compute for the XR device 305). The DDSP component 425 may determine the XR compute location to be the XR device 305 if the second estimated power consumption is greater than the first estimated power consumption (e.g., if P_remote>P_local). Alternatively, the DDSP component 425 may determine the XR compute location to be the external device 405 if the first estimated power consumption is greater than the second estimated power consumption (e.g., if P_remote<P_local).

In some cases, an estimated power consumption may include a combination of an estimated wireless radio power consumption (P_radio) of the XR device 305 and an estimated XR compute power consumption (P_compute) of the XR device 305. The estimated wireless radio power consumption may be a peak wireless radio power consumption, an average wireless radio power consumption, or a combination thereof. The DDSP component 425 may determine the estimated wireless radio power consumption based at least in part on information provided by the modem 420, which may include data rates, transmit power, device delay period, and/or channel utilization, among other parameters.

In some cases, the estimated XR compute power consumption may be a peak XR compute power consumption, an average XR compute power consumption, or a combination thereof. The DDSP component 425 may determine the estimated XR compute power consumption based at least in part on a type of compute tasks that are to be performed for XR compute, and/or historical measurements of power consumption for the compute tasks for the controller/processor of the XR device 305 (e.g., the central processing unit (CPU) of the XR device 305, the graphics processing unit (GPU) of the XR device 305).

The DDSP component 425 may determine an estimated power consumption (e.g., P_local, P_remote) based at least in part on the estimated wireless radio power consumption and the estimated XR compute power consumption (e.g., P_radio+P_compute). In particular, the DDSP component 425 may determine the first estimated power consumption as P_local=P_radio_local+P_compute_local, and may determine the second estimated power consumption as P_remote=P_radio_remote+P_compute_remote.

In some cases, the DDSP component 425 may determine the XR compute location based at least in part on other parameters, such as a packet loss rate between the application client at the XR device 305 and the network node 110, an RTT between the application client at the XR device 305 and the network node 110, a server load associated with the application server 310, and/or a network load associated with the network node 110, among other examples.

For example, the DDSP component 425 may determine the XR compute location to be the XR device 305 if the packet loss rate satisfies (e.g., exceeds, is equal to) a package loss rate threshold. As another example, the DDSP component 425 may determine the XR compute location to be an external device 405 if the packet loss rate does not satisfy (e.g., is less than, is equal to) the package loss rate threshold.

As another example, the DDSP component 425 may determine the XR compute location to be the XR device 305 if the RTT satisfies (e.g., exceeds, is equal to) an RTT threshold. As another example, the DDSP component 425 may determine the XR compute location to be an external device 405 if the RTT does not satisfy (e.g., is less than, is equal to) the RTT threshold.

As another example, the DDSP component 425 may determine the XR compute location to be the XR device 305 if a load of the external device 405 satisfies (e.g., exceeds, is equal to) a server load threshold. As another example, the DDSP component 425 may determine the XR compute location to be the external device 405 if the server load does not satisfy (e.g., is less than, is equal to) the server load threshold. Generally, the greater the server load, the fewer the resources that are available to be allocated to the XR device 305, which may result in increased delays even if radio conditions on the wireless radio link between the XR device 305 and the network node 110 are satisfactory.

As another example, the DDSP component 425 may determine the XR compute location to be the XR device 305 if the network load satisfies (e.g., exceeds, is equal to) a network load threshold. As another example, the DDSP component 425 may determine the XR compute location to be an external device 405 if the network load does not satisfy (e.g., is less than, is equal to) the network load threshold. Generally, the greater the network load, the fewer the resources that are available to be allocated to the XR device 305, which may result in increased delays even if radio conditions on the wireless radio link between the XR device 305 and the network node 110 are satisfactory.

In some cases, the DDSP component 425 may determine the XR compute location based at least in part on a combination of the above-described parameters (and/or other parameters). For example, the DDSP component 425 may assign appropriate weights to one or more of the parameters and may determine the XR compute location based at least in part on the weighted parameters. As an example, even if radio conditions on the wireless radio link between the XR device 305 at the network node 110 degrade, the DDSP component 425 may still maintain the XR compute location to be the external device 405 if power consumption at the XR device 305 is greater if the XR device 305 performs the XR compute than the power consumption at the XR device 305 if the external device 405 performs the XR compute (e.g., if (P_remote<P_local).

As shown by reference number 450, the DDSP component 425 may transmit a offload configuration to the perception algorithms component 430. For example, the DDSP component 425 may transmit the offload configuration to the perception algorithms component 430 via the first API.

In some cases, the offload configuration may indicate an XR compute location for a task, a portion of a task, and/or a group of tasks. In some cases, the XR offload configuration may indicate, for each task indicated in the algorithm information, whether the task (or a portion of a task) is to be offloaded to an external device, to multiple external device, or performed locally by the XR device 305.

In some cases, the offload configuration may include an identifier or other information that can be used to identify an external device to which a task (or a portion of a task) is to be offloaded. For example, the offload configuration may indicate that a first portion of a task is to be performed locally by the XR device 305. The offload configuration may indicate that a second portion of the task is to be performed at the application server 310. The offload configuration may indicate that a third portion of the task is to be performed at the on-premises server 460.

In some cases, the offload configuration may indicate one or more algorithm parameters associated with performing a task. For example, the offload configuration information may indicate that a task is to be performed at the application server 310 and that the application server 310 is to run the task at X frames per second and at Y resolution.

As shown by reference number reference number 455, the perception algorithms component 430 may selectively transmit an indication of the XR compute location to one or more devices, such as the application server 310, the on premises server 460, the laptop 465, and/or the UE 120.

As indicated above, FIG. 4 is provided as an example. Other examples may differ from what is described with regard to FIG. 4.

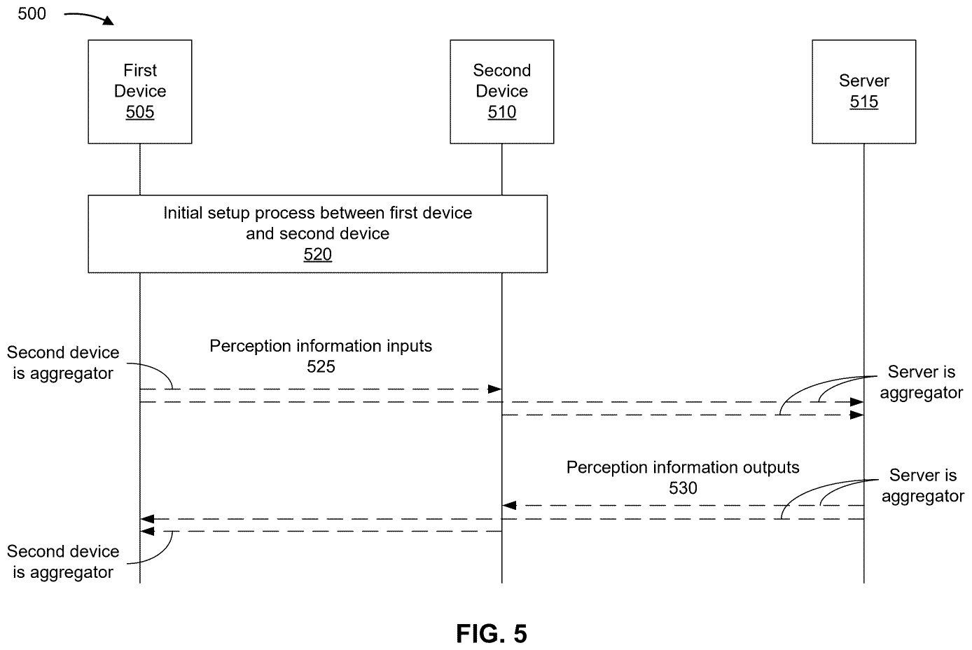

FIG. 5 is a diagram illustrating an example 500 of extended reality perception information sharing, in accordance with the present disclosure. A first device 505 may communicate with at least one of a second device 510 and a server 515. The first device 505 and the second device 510 may be XR devices. The first device 505 and the second device 510 may include one or more of the features of the XR device 305 and/or the UE 120.

In some aspects, the first device 505 and the second device 510 may be located in the same physical environment and/or may be running the same XR application, such as an AR gaming application. In some aspects, the first device 505 and the second device 510 may share the same VPS session. For example, the first device 505 and the second device 510 may share the same coordinate system for perception information. Therefore, when inputs from the first device 505 or the second device 510 are received at the server 515, the server 515 may not need to perform any coordinate system alignment between the first device 505 and the second device 510. In some aspects, a dynamic distributed split perception (DDSP) component of the first device 505 and a DDSP component of the second device 510 may be configured with server information associated with one or more servers that are capable of combining (e.g., merging) perception information from multiple devices (such as the first device 505 and the second device 510).

As shown by reference number 520, the first device 505 may perform an initial setup process between the first device 505 and the second device 510. The initial setup process may indicate that the first device 505 and the second device 510 are to share perception information associated with an XR application.

In some aspects, the first device 505 may detect (for example, discover) the second device 510 and/or the second device 510 may detect the first device 505. The first device 505 and the second device 510 may determine whether the first device 505 and the second device 510, respectively, are to share perception information, may coordinate as to which perception algorithm of a plurality of perception algorithms is to be shared, and/or may coordinate as to which server (if any) is to be used for perception information aggregation. For example, the first device 505 and the second device 510 may determine that the devices are located in the same physical environment and that the devices are hosting the same XR application. Therefore, the first device 505 and the second device 510 may determine to share perception information, such as three-dimensional rendering (3DR) information, directly or using a remote server (such as the server 515). In some aspects, the perception information includes environment information that indicates one or more characteristics of an environment associated with at least one of the first device 505 and the second device 510, object information that indicates one or more objects located in the environment, lighting information that indicates one or more lighting characteristics of the environment, positioning information that indicates a positioning characteristic of at least one of the first device 505 or the second device 510, or user information that indicates at least one of a characteristic of a user of the first device 505 or a characteristic of a user of the second device 510.

In a first example, the initial setup process may include a perception-service-based handshaking operation. In some aspects, the server 515 may include (or may be) a perception service. Therefore, the perception service may be remote from the first device 505 and the second device 510. The first device 505 and the second device 510 may begin offloading perception information (independently) to the perception service. Inputs to the perception service from the first device 505 and the second device 510 may be aligned with a coordinate system of a VPS session between the first device 505 and the second device 510. The perception service may determine whether the first device 505 and the second device 510 are in a VPS session. Based at least in part on determining that the first device 505 and the second device 510 are in the VPS session, the perception service may request that the first device 505 and the second device 510 share a VPS session identifier (ID) with the perception service. Based at least in part on receiving the request from the perception service, the first device 505 and the second device 510 may share the VPS session ID with the perception service. The perception service may determine that the first device 505 and the second device 510 are in the same VPS session and have the same coordinate system. Therefore, the perception service may determine that the first device 505 and the second device 510 are able to share perception information. The perception service may transmit a request to the first device 505 and the second device 510 associated with sharing the perception information. Based at least in part on the perception service receiving an indication that the first device 505 and the second device 510 are to share the perception information, the sharing of the perception information between the first device 505 and the second device 510 can begin.

In a second example, the initial setup process may include a cloud-based handshaking operation. The first device 505 and the second device 510 may detect (for example, discover) a cloud service that is capable of communicating with a perception service to coordinate perception information sharing between the first device 505 and the second device 510. In this example, the first device 505 and the second device 510 may transmit a perception discovery service request to the cloud server. The cloud server may transmit, to the first device 505 and the second device 510, an availability of the perception service. Additionally, the cloud server may determine whether the first device 505 and the second device 510 are in a VPS session. Based at least in part on the cloud server determining that the first device 505 and the second device 510 are in the VPS session, the cloud server may request that the first device 505 and the second device 510 share the VPS session ID with the cloud server. Based at least in part on receiving the request from the cloud server, the first device 505 and the second device 510 may share the VPS session ID with the cloud server. Based at least in part on receiving the VPS session ID, the cloud server may discover that the first device 505 and the second device 510 are in the same VPS session and have the same coordinate system. Therefore, the cloud server may determine that the first device 505 and the second device 510 are able to share perception information. The cloud server may transmit a request to the first device 505 and the second device 510 to share perception information with each other. Based at least in part on receiving an indication that the first device 505 and the second device 510 are to share perception information with each other, sharing of the perception information between the first device 505 and the second device 510 can begin.

In a third example, the initial setup process may include a VPS-based handshaking operation. A DDSP component of the first device 505 may detect a DDSP component of the second device 510, and/or the DDSP component of the second device 510 may detect the DDSP component of the first device 505. The DDSP component of the first device 505 may determine that sharing perception information (such as 3DR perception information) between the first device 505 and the second device is an offload option that is to be evaluated. In some aspects, an application component of the first device 505 may inform the DDSP component of the first device 505 regarding the DDSP component of the second device 510, and an application component of the second device 510 may inform the DDSP component of the second device 510 regarding the DDSP component of the first device 505. Additionally, or alternatively, a VPS connector may inform the DDSP component of the first device 505 regarding the DDSP component of the second device 510, and may inform the DDSP component of the second device 510 regarding the DDSP component of the first device 505. The DDSP component of the first device 505 and the DDSP component of the second device 510 may request that the VPS service coordinate a handshaking process between the first device 505 and the second device 510. For example, the first device 505 and the second device 510 may coordinate regarding which perception algorithm is able to be shared (for example, to build the 3DR) and/or regarding which remote servers can be used for sharing perception algorithms. The DDSP component of the first device 505 and the DDSP component of the second device 510 may run offload algorithms and may determine that perception information sharing between the first device 505 and the second device 510 is to be implemented. The DDSP component of the first device 505 and the DDSP component of the second device 510 may communicate using the VPS service to confirm that the perception information sharing between the first device 505 and the second device 510 is to be implemented. Thereafter, the server 515 may indicate the perception algorithms to be used by the first device 505 and the second device 510. Additionally, the DDSP component of the first device 505 and the DDSP component of the second device 510 may communicate regarding the perception information (for example, 3DR) offload and to determine one or more instructions that are to be implemented (for example, to merge the depth of both the first device 505 and the second device 510, and to send a single 3DR to both the first device 505 and the second device 510). Thereafter, perception information sharing by the first device 505 and the second device 510 may begin.

In a fourth example, the initial setup process may include a peer-to-peer (P2P)-based handshaking operation using a server. The DDSP component of the first device 505 may detect the DDSP component of the second device 510, and/or the DDSP component of the second device 510 may detect the DDSP component of the first device 505. For example, the DDSP component of the first device 505 may determine that sharing perception information (such as 3R perception information) between the first device 505 and the second device is an offload option that is to be evaluated. In some aspects, an application component of the first device 505 may inform the DDSP component of the first device 505 regarding the DDSP component of the second device 510, and an application component of the second device 510 may inform the DDSP component of the second device 510 regarding the DDSP component of the first device 505. Additionally, or alternatively, a VPS connector may inform the DDSP component of the first device 505 regarding the DDSP component of the second device 510, and may inform the DDSP component of the second device 510 regarding the DDSP component of the first device 505. The DDSP component of the first device 505 and the DDSP component of the second device 510 may coordinate a handshaking process between the first device 505 and the second device 510. For example, the first device 505 and the second device 510 may coordinate regarding which perception algorithm is able to be shared (for example, to build the 3DR) and/or which remote servers can be used for sharing the perception algorithms. The DDSP component of the first device 505 and the DDSP component of the second device 510 may run offload algorithms and may determine that perception information sharing between the first device 505 and the second device 510 is to be implemented. The DDSP component of the first device 505 and the DDSP component of the second device 510 may communicate (directly) to confirm that the perception information sharing between the first device 505 and the second device 510 is to be implemented. Thereafter, the DDSP component of the first device 505 and the DDSP component of the second device 510 may indicate the perception algorithms to be used by the first device 505 and the second device 510. Additionally, the DDSP component of the first device 505 and the DDSP component of the second device 510 may communicate regarding the perception information (for example, 3DR perception information) offload and to determine one or more instructions that are to be met (for example, to merge the depth of both the first device 505 and the second device 510 and to send a single 3DR to both the first device 505 and the second device 510). Thereafter, perception information sharing by the first device 505 and the second device 510 may begin.

In a fifth example, the initial setup process may include a P2P-based handshaking operation. The DDSP component of the first device 505 may detect the DDSP component of the second device 510, and the DDSP component of the second device 510 may detect the DDSP component of the first device 505. For example, the DDSP component of the first device 505 may determine that sharing perception information (such as 3DR perception information) between the first device 505 and the second device is an offload option that is to be evaluated. In some aspects, an application component of the first device 505 may inform the DDSP component of the first device 505 regarding the DDSP component of the second device 510, and an application component of the second device 510 may inform the DDSP component of the second device 510 regarding the DDSP component of the first device 505. Additionally, or alternatively, a VPS connector may inform the DDSP component of the first device 505 regarding the DDSP component of the second device 510, and may inform the DDSP component of the second device 510 regarding the DDSP component of the first device 505. The DDSP component of the first device 505 and the DDSP component of the second device 510 may coordinate a handshaking process between the first device 505 and the second device 510. For example, the first device 505 and the second device 510 may coordinate regarding which perception algorithm is able to be shared (for example, to build the 3DR). Additionally, or alternatively, the first device 505 and the second device 510 may determine the role of each device in the perception sharing process. Since there is no remote server involved, either the first device 505 or the second device 510 may be responsible for coordinating the perception sharing process. For example, the first device 505 may be considered the host device, may receive perception information inputs from the second device 510, may generate combined perception information in accordance with the perception information of the first device 505 and the perception information of the second device 510, and may transmit the combined perception information to the second device 510. The DDSP component of the first device 505 and the DDSP component of the second device 510 may run offload algorithms and may determine that perception information sharing between the first device 505 and the second device 510 is to be implemented. In some aspects, the DDSP component of the first device 505 and the DDSP component of the second device 510 may communicate using the VPS service to confirm that the perception information sharing between the first device 505 and the second device 510 is to be implemented. Thereafter, the server 515 may indicate the perception algorithms to be used by the first device 505 and the second device 510. In some other aspects, the DDSP component of the first device 505 and the DDSP component of the second device 510 may communicate (directly) to confirm that the perception information sharing between the first device 505 and the second device 510 is to be implemented. Thereafter, the DDSP component of the first device 505 may indicate the perception algorithms to be used by the first device 505 and the second device 510. The DDSP component of the first device 505 and the DDSP component of the second device 510 may communicate regarding the perception information (for example, 3DR perception information) offload and to determine one or more instructions that are to be met (for example, to merge the depth of both the first device 505 and the second device 510 and to send a single 3DR to both the first device 505 and the second device 510). Thereafter, perception information sharing by the first device 505 and the second device 510 may begin.

As shown by reference number 525, the first device 505 may transmit one or more perception information inputs associated with the first device 505. Additionally, or alternatively, the second device 510 may transmit one or more perception information inputs associated with the second device 510. In some aspects, the first device 505 may transmit the one or more perception information inputs to the server 515. For example, the first device 505 may transmit, and the server 515 may receive, the one or more perception information inputs. In some other aspects, the first device 505 may transmit the one or more perception information inputs to the second device 510. For example, the first device 505 may transmit, and the second device 510 may receive, the one or more perception information inputs.

As shown by reference number 530, the first device 505 may receive one or more perception information outputs. The one or more perception information outputs may include combined perception information that is based at least in part on the one or more first perception information inputs associated with the first device 505 and on one or more second perception information inputs associated with the second device 510. In some aspects, the first device 505 may receive the one or more perception information outputs from the server 515. For example, the server 515 may transmit, and the first device 505 may receive, the one or more perception information outputs. In some other aspects, the first device 505 may receive the one or more perception information outputs from the second device 510. For example, the second device 510 may transmit, and the first device 505 may receive, the one or more perception information outputs.

In some aspects, the combined perception information outputs may be generated by the server 515. The server 515 may transmit instructions to at least one of the first device 505 or the second device 510. In some aspects, the instructions may indicate a time at which the first device 505 or the second device 510 is to send the perception information inputs to the server 515. In some aspects, the instructions may indicate how a perception algorithm used by the first device 505 or the second device 510 is to be configured. In some aspects, the instructions may indicate one or more key performance indicators (KPIs) that are to be sent by the first device 505 or the second device 510 to the server 515. Based at least in part on receiving the instructions, the first device 505 and the second device 510 (for example, a perception algorithm of the first device 505 and a perception algorithm of the second device 510) may transmit the perception information inputs (such as depth maps and 6DoF perception information) to the server 515. The server 515 may receive the first perception information inputs (associated with the first device 505) and the second perception information inputs (associated with the second device 510) and may generate a combined perception information output using the first perception information inputs and the second perception information inputs. The server 515 may transmit the combined perception information output to the first device 505 and the second device 510. Since the server 515 is configured with the coordinate information of the first device 505 and the second device 510, for example, via the VPS, the server 515 may not perform an alignment for the coordinate systems of the first device 505 and the second device 510.

In some aspects, the server 515 may request that the first device 505 and the second device 510 send specific inputs or key performance indicators to assist the server 515 with identifying when inputs are needed from each device and/or to assist the server 515 with identifying the configuration of each input. For example, the server 515 may transmit a request to at least one of the first device 505 or the second device 510 to receive information associated with a battery level of the device, a position or pose of the device, or a capability of the device. In one example, based at least in part on receiving an indication that the first device 505 (and/or the second device 510) has a low battery level, the server 515 may request that the first device 505 (and/or the second device 510) reduce an input FPS in order to reduce battery consumption by the first device 505. In another example, the server 515 may request that the first device 505 only transmit inputs associated with certain areas of the environment. For example, a position or pose of the first device 505 may already be included in the perception information and, therefore, may not be needed as an additional input or key performance indicator. In another example, the server 515 may request that the first device 505 transmit capability information to the server 515. For example, the server 515 may request that the first device 505 transmit more frequent inputs in accordance with the first device 505 having a wider field of view (FOV) or may request that the first device 505 transmit less frequent inputs in accordance with the first device 505 having a narrower field of view. In another example, the server 515 may request that the first device 505 not transmit any inputs in accordance with a maximum frames per second (FPS) or resolution of the first device 505 being below an FPS threshold or a resolution threshold.

In some aspects, based at least in part on the inputs or key performance indicators received from the first device 505 and/or the second device 510, the server 515 may request that the first device 505 and/or the second device 510 only transmit perception information inputs (such as camera data, 6DoF information, or depth map information, among other examples) in one or more scenarios. In one example, the server 515 may request that the first device 505 (and/or the second device 510) only transmit perception information inputs in accordance with the first device 505 being within a certain part of the environment or in accordance with a pose of the first device 505 being in a certain direction. For example, if two or more devices are building collaborative 3DR or light estimation, the server 515 may assign each of those devices a particular area of the environment to scan. This may reduce power consumption at the devices. In another example, the server 515 may request that the first device 505 only transmit perception information inputs in accordance with the first device 505 detecting a certain scene. For example, the server 515 may instruct a device only to send perception information inputs if the device detects a change in an environment that requires an update to an existing 3DR or light estimation. This may result in improved perception quality. In another example, the server 515 may request that the first device 505 only transmit perception information inputs in accordance with the first device 505 moving at a speed that satisfies a speed threshold. This may reduce redundant inputs to the server 515 and may enable power savings at the device. In another example, the server 515 may request that the first device 505 only transmit perception information inputs in accordance with the first device 505 supporting an FPS or a resolution that satisfies an FPS threshold or a resolution threshold, respectively. This may be application dependent. For example, in accordance with the server 515 building collaborative perception above a certain quality, the server 515 may request that devices with low quality (for example, with FPS or resolution below the FPS threshold or resolution threshold) not send any inputs to the server 515. This may enable power savings at the devices and may enable the combined perception to be of higher quality (for example, higher resolution).

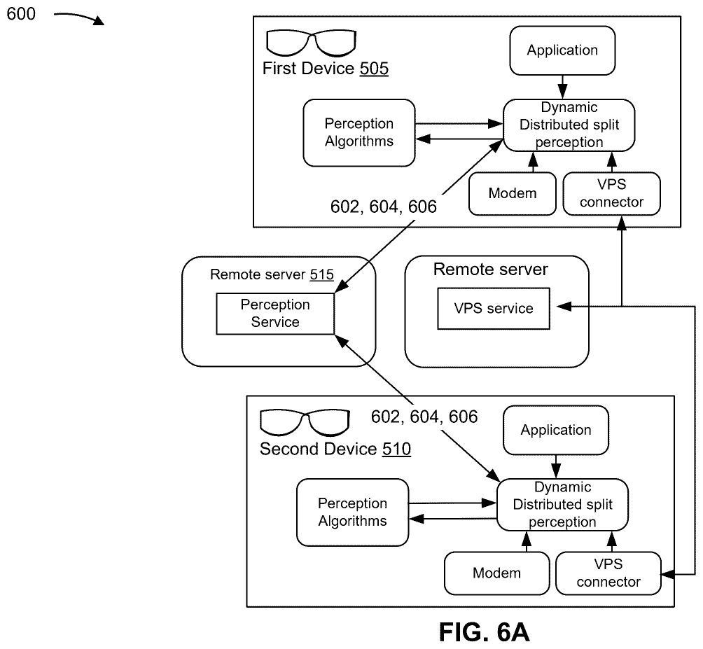

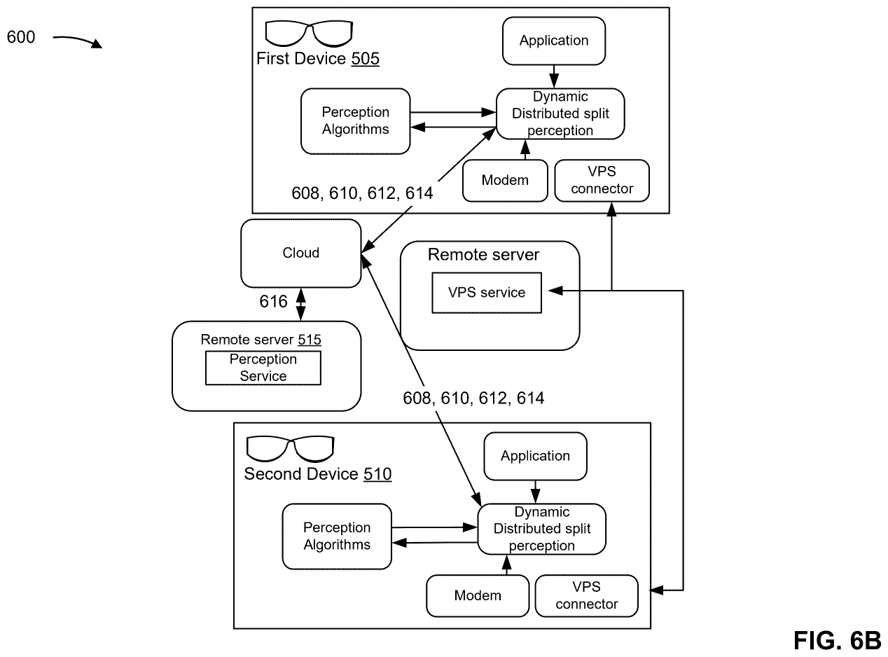

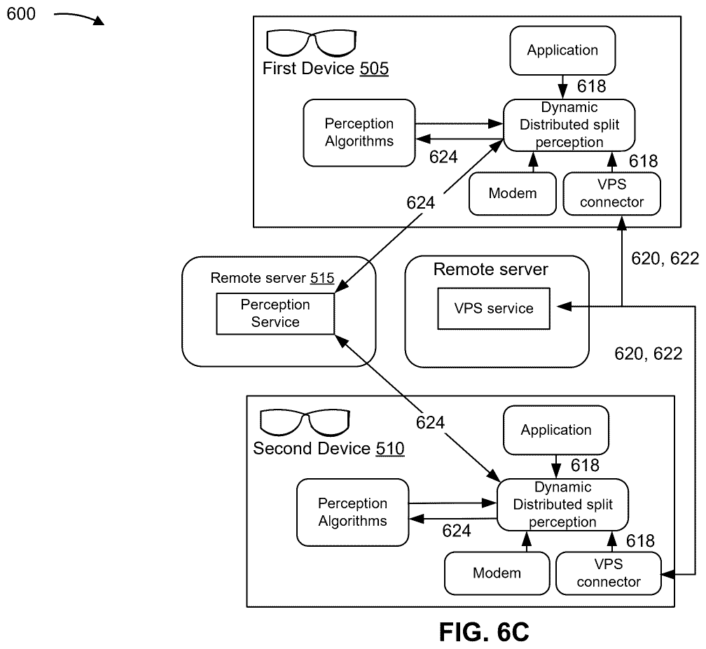

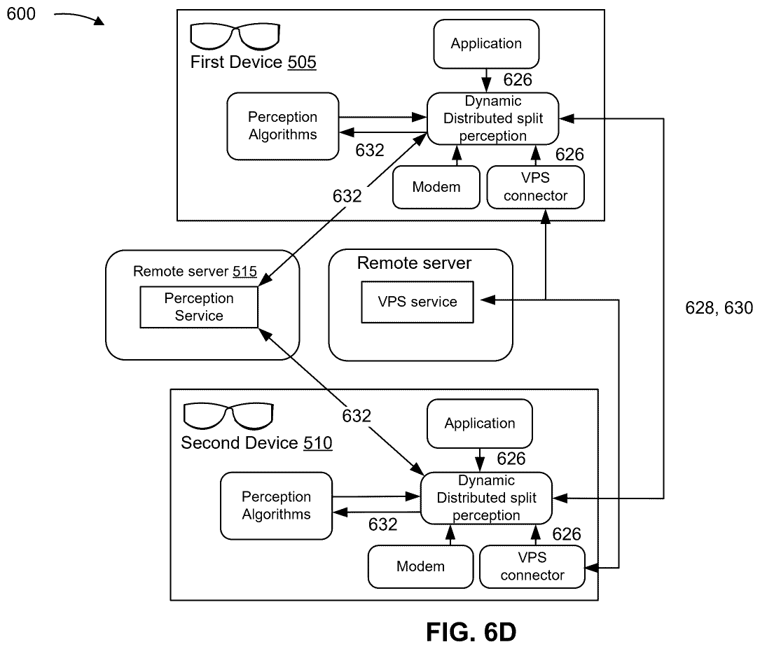

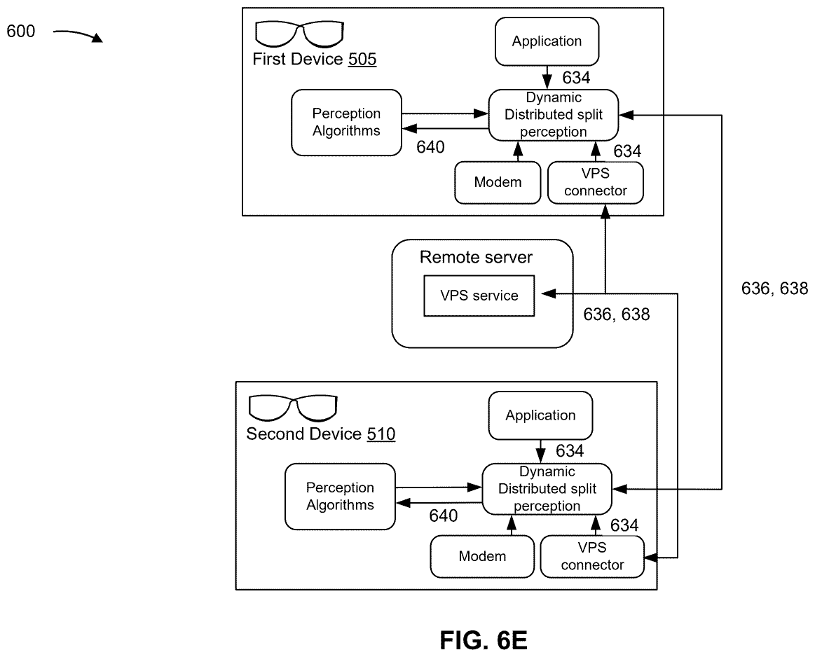

In some aspects, based at least in part on the inputs or key performance indicators received from the first device 505 and/or the second device 510, the server 515 may configure the inputs to be sent by the users in accordance with one or more conditions. In one example, the server 515 may instruct the first device 505 (and/or the second device 510) to send inputs using a certain resolution, quality, or frame rate, among other examples. For example, the server 515 may instruct the first device 505 to set an FPS or resolution to a certain FPS or resolution based at least in part on a maximum supported FPS or resolution supported by the first device 505. This may result in power savings at the device and better quality of perception at the server 515. If the first device 505 and the second device 510 reduce respective FPS inputs, both the first device 505 and the second device 510 may experience power savings, for example, due to computing fewer inputs and building perception information more quickly. Additionally, or alternatively, the server 515 may request the device with the higher resolution input to increase the FPS (and vice versa). This may result in increased quality of the perception information and may result in power savings for at least one of the devices. In another example, the server 515 may instruct the first device 505 to send inputs using a specific algorithm with certain parameters. For example, based at least in part on the first device 505 supporting depth map computation using depth from stereo and using ML, the server 515 may request that the first device 505 use a certain algorithm based at least in part on a desired quality. For example, the server 515 may request that the first device 505 use ML for higher quality inputs and use depth from stereo for lower quality inputs. In another example, the server 515 may instruct the first device 505 to send inputs in accordance with a description of one or more objects to be detected. For example, for a server 515 computing 3DR, the server 515 may request that the first device 505 send image segmentation to the server 515 only when walls and tables are detected. Additional details regarding these features are described in connection with FIG. 6.

In some aspects, the combined perception information outputs may be generated by the first device 505 or the second device 510. In some aspects, the second device 510 may serve as the host device (for example, the aggregator of the perception information inputs). The second device 510 may transmit instructions to the first device 505. In some aspects, the instructions may indicate a time at which the first device 505 is to send the perception information inputs to the second device 510. In some aspects, the instructions may indicate how a perception algorithm used by the first device 505 is to be configured. In some aspects, the instructions may indicate one or more key performance indicators that are to be sent by the first device 505 to the second device 510. Based at least in part on receiving the instructions, the first device 505 (for example, a perception algorithm of the first device 505) may transmit the perception information inputs (such as depth maps and 6DoF perception information) to the second device 510. The second device 510 may receive the first perception information inputs (associated with the first device 505) and may generate a combined perception information output using the first perception information inputs and using second perception information inputs associated with the second device 510. The second device 510 may transmit the combined perception information output to the first device 505. Since the second device 510 is configured with the coordinate information of the first device 505, for example, via the VPS, the second device 510 may not perform an alignment for the coordinate systems of the first device 505 and the second device 510.

In some aspects, the second device 510 may request that the first device 505 send specific inputs or key performance indicators to assist the second device 510 with identifying when inputs are needed from the first device 505 and/or to assist the second device 510 with identifying the configuration of each input. For example, the second device 510 may transmit a request to the first device 505 to receive information associated with a battery level of the device, a position or pose of the device, or a capability of the device. In one example, based at least in part on receiving an indication that the first device 505 has a low battery level, the second device 510 may request that the first device 505 reduce an input FPS in order to reduce battery consumption by the first device 505. In another example, the second device 510 may request that the first device 505 only transmit inputs associated with certain areas of the environment. For example, a position or pose of the first device 505 may already be included in the perception information and, therefore, may not be needed as an additional input or key performance indicator. In another example, the second device 510 may request that the first device 505 transmit capability information to the second device 510. For example, the second device 510 may request that the first device 505 transmit more frequent inputs in accordance with the first device 505 having a wider field of view (FOV), or may request that the first device 505 transmit less frequent inputs in accordance with the first device 505 having a narrower field of view. In another example, the second device 510 may request that the first device 505 not transmit any inputs in accordance with a maximum frames per second (FPS) or resolution of the first device 505 being below an FPS threshold or a resolution threshold.

In some aspects, based at least in part on the inputs or key performance indicators received from the first device 505, the second device 510 may request that the first device 505 only transmit perception information inputs (such as camera data, 6DoF information, or depth map information, among other examples) in one or more scenarios. In one example, the second device 510 may request that the first device 505 only transmit perception information inputs in accordance with the first device 505 being within a certain part of the environment or in accordance with a pose of the first device 505 being in a certain direction. For example, if two or more devices are building collaborative 3DR or light estimation, the second device 510 may assign each of those devices a particular area of the environment to scan. This may reduce power consumption at the devices. In another example, the second device 510 may request that the first device 505 only transmit perception information inputs in accordance with the first device 505 detecting a certain scene. For example, the second device 510 may instruct a device only to send perception information inputs if the device detects a change in an environment that requires an update to an existing 3DR or light estimation. This may result in improved perception quality. In another example, the second device 510 may request that the first device 505 only transmit perception information inputs in accordance with the first device 505 moving at a speed that satisfies a speed threshold. This may reduce redundant inputs to the second device 510 and may enable power savings at the first device 505. In another example, the second device 510 may request that the first device 505 only transmit perception information inputs in accordance with the first device 505 supporting an FPS or a resolution that satisfies an FPS threshold or a resolution threshold, respectively. This may be application dependent. For example, in accordance with the second device 510 building collaborative perception above a certain quality, the second device 510 may request that devices with low quality (for example, with FPS or resolution below the FPS threshold or resolution threshold) not send any inputs to the second device 510. This may enable power savings at the first device 505 and may enable the combined perception to be of higher quality (for example, higher resolution).

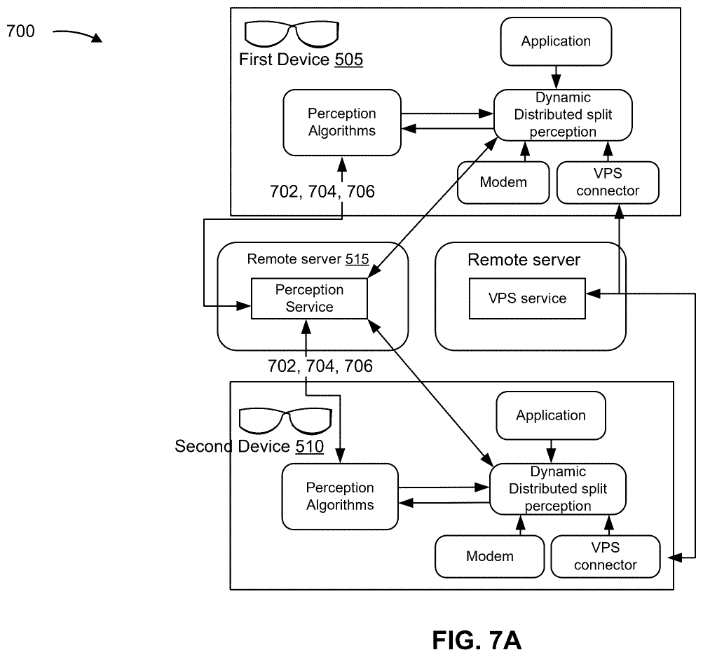

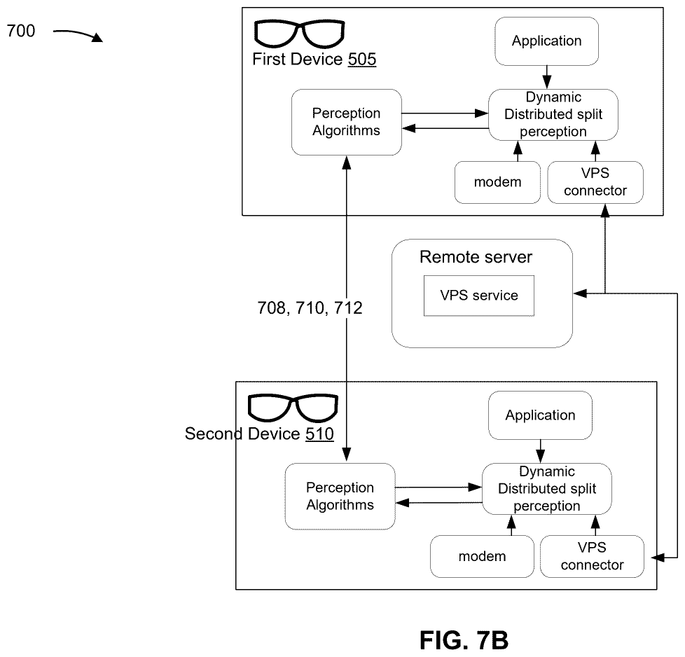

In some aspects, based at least in part on the inputs or key performance indicators received from the first device 505, the second device 510 may configure the inputs to be sent by the users in accordance with one or more conditions. In one example, the second device 510 may instruct the first device 505 to send inputs using a certain resolution, quality, or frame rate, among other examples. For example, the second device 510 may instruct the first device 505 to set an FPS or resolution to a certain FPS or resolution based at least in part on a maximum supported FPS or resolution supported by the first device 505. This may result in power savings at the first device 505 and better quality of perception at the second device 510. If the first device 505 and the second device 510 lower respective FPS inputs, both the first device 505 and the second device 510 may experience power savings, for example, due to computing fewer inputs and building perception information more quickly. Additionally, or alternatively, the second device 510 may request the device with the higher resolution input to increase the FPS (and vice versa). This may result in increased quality of the perception information and may result in power savings for at least one of the devices. In another example, the second device 510 may instruct the first device 505 to send inputs using a specific algorithm with certain parameters. For example, based at least in part on the first device 505 supporting depth map computation using depth from stereo and using ML, the second device 510 may request that the first device 505 use a certain algorithm based at least in part on a desired quality. For example, the second device 510 may request that the first device 505 use ML for higher quality inputs and use depth from stereo for lower quality inputs. In another example, the second device 510 may instruct the first device 505 to send inputs in accordance with a description of one or more objects to be detected. For example, for a second device 510 computing 3DR, the second device 510 may request that the first device 505 send image segmentation to the second device 510 only when walls and tables are detected. Additional details regarding these features are described in connection with FIG. 7.

In some examples, rather than building a 3DR alone, multiple devices may collaborate to build a joint 3DR. For example, each device may send separate depth maps and receive an aggregated 3DR. In this case, each device may scan only portions of the environment, which may enable power savings at the devices. Additionally, each device may lower a scan resolution (for example, an FPS), which may enable power savings at the devices. Further, devices with lower quality depth maps and segmentation may benefit from higher quality depth maps and segmentation from other devices, which may enable improved 3DR quality. Even further, devices may save the built 3DR in a cloud for future use by the same or different users, which may enable power savings and improved 3DR quality.

In some examples, such as with light estimation, an XR device (such as AR glasses) may estimate the lighting intensity across the environment for more realistic rending of objects in the AR environment. Different devices estimating light from different parts of the environment may result in significant power savings as well as improved light estimation.

In some examples, such as with 3D semantic segmentation, an XR device (such as AR glasses) may classify objects in the environment. For example, a table is in one part of a room and a chair is in a different part of the room. Different devices sharing their 3D semantic segmentation may result in significant power savings as well as improved (more accurate) 3D semantic segmentation from more powerful devices.

In some examples, VPS positioning can be augmented with mutual visual positioning. For example, one head-mounted display (HMD) may use cameras to detect the relative position of another HMD. This information may be used to augment the VPS, which may enable improved positioning and perception quality.

In some examples, during a device interaction with the environment, a quality of experience may be limited due to the device's position and specific environmental conditions. For example, the presence of light sources and/or a poor perspective by the device may increase a difficulty for some tasks such as tracking, detection, or spatial rendering. This may be mitigated by the sensory information of additional devices located in different positions, thereby leading to an improved quality of experience.

In some examples, capturing user behavior or poses, such as the user crossing their arms or placing their hands in pockets for better avatar representation, may only be able to be captured from a different perspective than a current perspective of a device. If a different device is able to share camera inputs associated with the user, the avatar representation of the user may be significantly improved.

As indicated above, FIG. 5 is provided as an example. Other examples may differ from what is described with regard to FIG. 5.

FIGS. 6A-6E are diagrams illustrating examples 600 of initial setup processes between a first device and a second device, in accordance with the present disclosure.

As shown in FIG. 6A, an initial setup process may include a perception-service-based handshaking operation. In some aspects, the server 515 may include (or may be) a perception service. Therefore, the perception service may be remote from the first device 505 and the second device 510. The first device 505 and the second device 510 may begin offloading perception information (independently) to the perception service. Inputs to the perception service from the first device 505 and the second device 510 may be aligned with a coordinate system of a VPS session between the first device 505 and the second device 510. As shown by reference number 602, the perception service may determine whether the first device 505 and the second device 510 are in a VPS session. As shown by reference number 604, based at least in part on determining that the first device 505 and the second device 510 are in the VPS session, the perception service may request that the first device 505 and the second device 510 share the VPS session ID with the perception service. Based at least in part on receiving the request from the perception service, the first device 505 and the second device 510 may share the VPS session ID with the perception service. The perception service may determine that the first device 505 and the second device 510 are in the same VPS session and have the same coordinate system. Therefore, the perception service may determine that the first device 505 and the second device 510 are able to share perception information. As shown by reference number 606, the perception service may transmit a request to the first device 505 and the second device 510 associated with sharing the perception information. Based at least in part on the perception service receiving an indication that the first device 505 and the second device 510 are to share the perception information, the sharing of the perception information between the first device 505 and the second device 510 can begin.

As shown in FIG. 6B, the initial setup process may include a cloud-based handshaking operation. The first device 505 and the second device 510 may detect a cloud service that is capable of communicating with a perception service to coordinate perception information sharing between the first device 505 and the second device 510. As shown by reference number 608, the first device 505 and the second device 510 may transmit a perception discovery service request to the cloud server. As shown by reference number 610, the cloud server may transmit, to the first device 505 and the second device 510, an availability of the perception service. As shown by reference number 612, the cloud server may determine whether the first device 505 and the second device 510 are in a VPS session. Based at least in part on the cloud server determining that the first device 505 and the second device 510 are in the VPS session, the cloud server may request that the first device 505 and the second device 510 share the VPS session ID with the cloud server. As shown by reference number 614, based at least in part on receiving the request from the cloud server, the first device 505 and the second device 510 may share the VPS session ID with the cloud server. Based at least in part on receiving the VPS session ID, the cloud server may discover that the first device 505 and the second device 510 are in the same VPS session and have the same coordinate system. Therefore, the cloud server may determine that the first device 505 and the second device 510 are able to share perception information. As shown by reference number 616, the cloud server may transmit a request to the first device 505 and the second device 510 to share perception information with each other. Based at least in part on receiving an indication that the first device 505 and the second device 510 are to share perception information with each other, sharing of the perception information between the first device 505 and the second device 510 can begin.

As shown in FIG. 6C, the initial setup process may include a VPS-based handshaking operation. As shown by reference number 618, a DDSP component of the first device 505 may detect a DDSP component of the second device 510, and the DDSP component of the second device 510 may detect the DDSP component of the first device 505. The DDSP component of the first device 505 may determine that sharing perception information (such as 3DR perception information) between the first device 505 and the second device is an offload option that is to be evaluated. In some aspects, an application component of the first device 505 may inform the DDSP component of the first device 505 regarding the DDSP component of the second device 510, and an application component of the second device 510 may inform the DDSP component of the second device 510 regarding the DDSP component of the first device 505. Additionally, or alternatively, a VPS connector may inform the DDSP component of the first device 505 regarding the DDSP component of the second device 510, and may inform the DDSP component of the second device 510 regarding the DDSP component of the first device 505. As shown by reference number 620, the DDSP component of the first device 505 and the DDSP component of the second device 510 may request that the VPS service coordinate a handshaking process between the first device 505 and the second device 510. For example, the first device 505 and the second device 510 may coordinate regarding which perception algorithm is able to be shared (for example, to build the 3DR) and/or regarding which remote servers can be used for sharing perception algorithms. As shown by reference number 622, the DDSP component of the first device 505 and the DDSP component of the second device 510 may run offload algorithms and may determine that perception information sharing between the first device 505 and the second device 510 is to be implemented. The DDSP component of the first device 505 and the DDSP component of the second device 510 may communicate using the VPS service to confirm that the perception information sharing between the first device 505 and the second device 510 is to be implemented. As shown by reference number 624, the server 515 may indicate the perception algorithms to be used by the first device 505 and the second device 510. Additionally, the DDSP component of the first device 505 and the DDSP component of the second device 510 may communicate regarding the perception information (for example, 3DR) offload and to determine one or more instructions that are to be met (for example, to merge the depth of both the first device 505 and the second device 510, and to send a single 3DR to both the first device 505 and the second device 510). Thereafter, perception information sharing by the first device 505 and the second device 510 may begin.

As shown in FIG. 6D, the initial setup process may include a P2P-based handshaking operation using a server. As shown by reference number 626, the DDSP component of the first device 505 may detect the DDSP component of the second device 510, and the DDSP component of the second device 510 may detect the DDSP component of the first device 505. For example, the DDSP component of the first device 505 may determine that sharing perception information (such as 3DR perception information) between the first device 505 and the second device is an offload option that is to be evaluated. In some aspects, an application component of the first device 505 may inform the DDSP component of the first device 505 regarding the DDSP component of the second device 510, and an application component of the second device 510 may inform the DDSP component of the second device 510 regarding the DDSP component of the first device 505. Additionally, or alternatively, a VPS connector may inform the DDSP component of the first device 505 regarding the DDSP component of the second device 510, and may inform the DDSP component of the second device 510 regarding the DDSP component of the first device 505. As shown by reference number 628, the DDSP component of the first device 505 and the DDSP component of the second device 510 may coordinate a handshaking process between the first device 505 and the second device 510. For example, the first device 505 and the second device 510 may coordinate regarding which perception algorithm is able to be shared (for example, to build the 3DR) and/or which remote servers can be used for sharing the perception algorithms. As shown by reference number 630, the DDSP component of the first device 505 and the DDSP component of the second device 510 may run offload algorithms and may determine that perception information sharing between the first device 505 and the second device 510 is to be implemented. The DDSP component of the first device 505 and the DDSP component of the second device 510 may communicate (directly) to confirm that the perception information sharing between the first device 505 and the second device 510 is to be implemented. As shown by reference number 632, the DDSP component of the first device 505 and the DDSP component of the second device 510 may indicate the perception algorithms to be used by the first device 505 and the second device 510. Additionally, the DDSP component of the first device 505 and the DDSP component of the second device 510 may communicate regarding the perception information (for example, 3DR perception information) offload and to determine one or more instructions that are to be met (for example, to merge the depth of both the first device 505 and the second device 510, and to send a single 3DR to both the first device 505 and the second device 510).

Thereafter, perception information sharing by the first device 505 and the second device 510 may begin.

As shown in FIG. 6E, the initial setup process may include a P2P-based handshaking operation. As shown by reference number 634, the DDSP component of the first device 505 may detect the DDSP component of the second device 510, and the DDSP component of the second device 510 may detect the DDSP component of the first device 505. For example, the DDSP component of the first device 505 may determine that sharing perception information (such as 3DR perception information) between the first device 505 and the second device is an offload option that is to be evaluated. In some aspects, an application component of the first device 505 may inform the DDSP component of the first device 505 regarding the DDSP component of the second device 510, and an application component of the second device 510 may inform the DDSP component of the second device 510 regarding the DDSP component of the first device 505. Additionally, or alternatively, a VPS connector may inform the DDSP component of the first device 505 regarding the DDSP component of the second device 510, and may inform the DDSP component of the second device 510 regarding the DDSP component of the first device 505. As shown by reference number 636, the DDSP component of the first device 505 and the DDSP component of the second device 510 may coordinate a handshaking process between the first device 505 and the second device 510. For example, the first device 505 and the second device 510 may coordinate regarding which perception algorithm is able to be shared (for example, to build the 3DR). Additionally, or alternatively, the first device 505 and the second device 510 may determine the role of each device in the perception sharing process. Since there is no remote server involved, either the first device 505 or the second device 510 may be responsible for coordinating the perception sharing process. For example, the first device 505 may be considered the host device, may receive perception information inputs from the second device 510, may generate combined perception information in accordance with the perception information of the first device 505 and the perception information of the second device 510, and may transmit the combined perception information to the second device 510. As shown by reference number 638, the DDSP component of the first device 505 and the DDSP component of the second device 510 may run offload algorithms and may determine that perception information sharing between the first device 505 and the second device 510 is to be implemented. In some aspects, the DDSP component of the first device 505 and the DDSP component of the second device 510 may communicate using the VPS service to confirm that the perception information sharing between the first device 505 and the second device 510 is to be implemented. Thereafter, the server 515 may indicate the perception algorithms to be used by the first device 505 and the second device 510. In some other aspects, the DDSP component of the first device 505 and the DDSP component of the second device 510 may communicate (directly) to confirm that the perception information sharing between the first device 505 and the second device 510 is to be implemented. Thereafter, the DDSP component of the first device 505 may indicate the perception algorithms to be used by the first device 505 and the second device 510. As shown by reference number 640, the DDSP component of the first device 505 and the DDSP component of the second device 510 may communicate regarding the perception information (for example, 3DR perception information) offload and to determine one or more instructions that are to be met (for example, to merge the depth of both the first device 505 and the second device 510 and to send a single 3DR to both the first device 505 and the second device 510). Thereafter, perception information sharing by the first device 505 and the second device 510 may begin.

As indicated above, FIGS. 6A-6E are provided as examples. Other examples may differ from what is described with regard to FIGS. 6A-6E.

FIGS. 7A-7B are diagrams illustrating examples 700 of perception information sharing between a first device and a second device, in accordance with the present disclosure.

As shown in FIG. 7A, the server 515 may generate combined perception information outputs. As shown by reference number 702, the server 515 may transmit instructions to at least one of the first device 505 or the second device 510. In some aspects, the instructions may indicate a time at which the first device 505 or the second device 510 is to send the perception information inputs to the server 515. In some aspects, the instructions may indicate how a perception algorithm used by the first device 505 or the second device 510 is to be configured. In some aspects, the instructions may indicate one or more key performance indicators that are to be sent by the first device 505 or the second device 510 to the server 515. As shown by reference number 704, based at least in part on receiving the instructions, the first device 505 and the second device 510 (for example, a perception algorithm of the first device 505 and a perception algorithm of the second device 510) may transmit the perception information inputs (such as depth maps and 6DoF perception information) to the server 515. As shown by reference number 706, the server 515 may receive the first perception information inputs (associated with the first device 505) and the second perception information inputs (associated with the second device 510) and may generate a combined perception information output using the first perception information inputs and the second perception information inputs. The server 515 may transmit the combined perception information output to the first device 505 and the second device 510. Since the server 515 is configured with the coordinate information of the first device 505 and the second device 510, for example, via the VPS, the server 515 may not perform an alignment for the coordinate systems of the first device 505 and the second device 510.

As shown in FIG. 7B, the first device 505 or the second device 510 may generate the combined perception information outputs. In some aspects, the second device 510 may serve as the host device (for example, the aggregator of the perception information inputs). As shown by reference number 708, the second device 510 may transmit instructions to the first device 505. In some aspects, the instructions may indicate a time at which the first device 505 is to send the perception information inputs to the second device 510. In some aspects, the instructions may indicate how a perception algorithm used by the first device 505 is to be configured. In some aspects, the instructions may indicate one or more key performance indicators that are to be sent by the first device 505 to the second device 510. As shown by reference number 710, based at least in part on receiving the instructions, the first device 505 (for example, a perception algorithm of the first device 505) may transmit the perception information inputs (such as depth maps and 6DoF perception information) to the second device 510. As shown by reference number 712, the second device 510 may receive the first perception information inputs (associated with the first device 505) and may generate a combined perception information output using the first perception information inputs and using second perception information inputs associated with the second device 510. The second device 510 may transmit the combined perception information output to the first device 505. Since the second device 510 is configured with the coordinate information of the first device 505, for example, via the VPS, the second device 510 may not perform an alignment for the coordinate systems of the first device 505 and the second device 510.

As indicated above, FIGS. 7A-7B are provided as examples. Other examples may differ from what is described with regard to FIGS. 7A-7B.

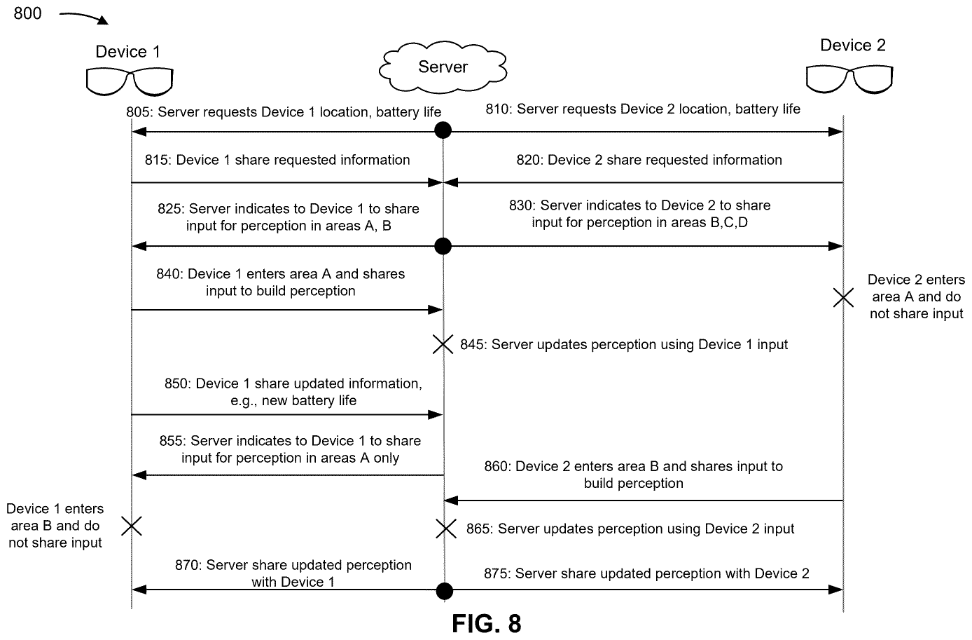

FIG. 8 is a diagram illustrating an example 800 of perception information sharing between one or more devices and a server, in accordance with the present disclosure. A server may communicate with a first device (Device 1) and a second device (Device 2). In some aspects, the Device 1 and the Device 2 may include some or all of the features of the first device 505 and/or the second device 510.

As shown by reference number 805, a server may transmit, and the Device 1 may receive, a request for location information and battery life information of the Device 1. As shown by reference number 810, the server may transmit, and the Device 2 may receive, a request for location information and battery life information of the Device 2. As shown by reference number 815, the Device 1 may transmit at least one of the location information or the battery life information to the server. As shown by reference number 820, the Device 2 may transmit at least one of the location information or the battery life information to the server. As shown by reference number 825, the server may transmit, and the Device 1 may receive, a request for the Device 1 to share input for perception area A and perception area B. As shown by reference number 830, the server may transmit, and the Device 2 may receive, a request for the Device 2 to share input for perception area B, perception area C, and perception area D. As shown by reference number 840, the Device 1 enters perception area A and shared input to build perception information associated with perception area A. The Device 2 does not enter perception area A and, therefore, does not share perception information associated with perception area A. As shown by reference number 845, the server updates the perception information using the input provided by the Device 1.

As shown by reference number 850, the Device 1 may transmit updated information, such as a new battery life indication, to the server. As shown by reference number 855, the server may transmit, and the Device 1 may receive, an indication for Device 1 to share input only for perception area A. As shown by reference number 860, the Device 2 enters perception area B and shares input with the server regarding perception area B. The Device 1 does not enter perception area B and, therefore, does not share input associated with perception area B. As shown by reference number 865, the server updates the perception information using the input provided by the Device 2. As shown by reference number 870, the server shares the updated perception information with the Device 1. As shown by reference number 875, the server shares the updated perception information with the Device 2.

As indicated above, FIG. 8 is provided as an example. Other examples may differ from what is described with regard to FIG. 8.

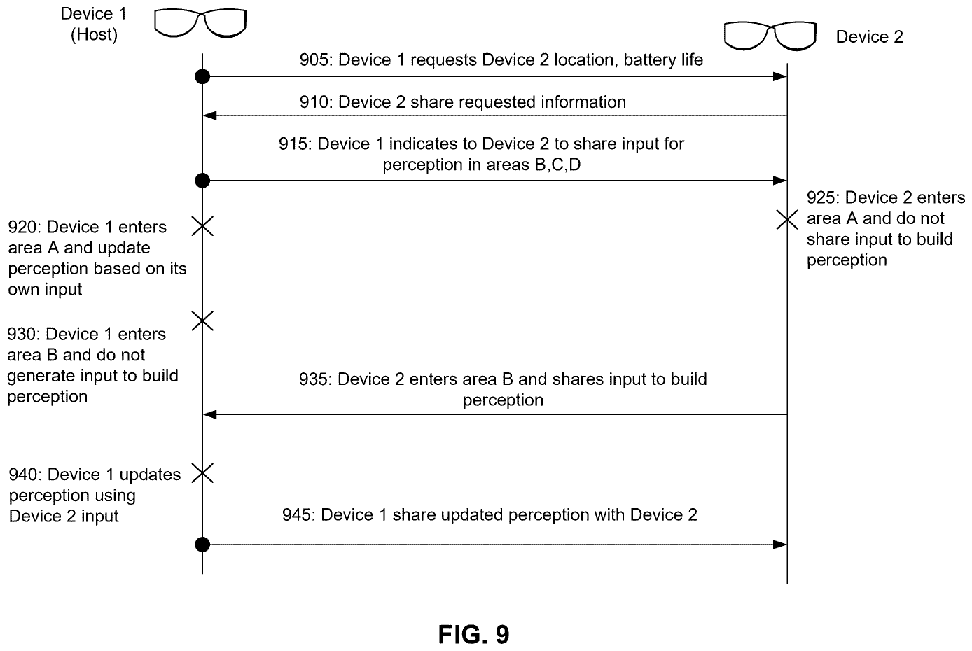

FIG. 9 is a diagram illustrating an example 900 of perception information sharing between two or more devices, in accordance with the present disclosure. A first device (Device 1) may communicate with a second device (Device 2). In some aspects, the Device 1 and the Device 2 may include some or all of the features of the first device 505 and/or the second device 510.

As shown by reference number 905, the Device 1 may transmit, and the Device 2 may receive, a request for at least one of location information or battery life information of the Device 2. As shown by reference number 910, the Device 2 may transmit, and the Device 1 may receive, at least one of the location information or the battery life information of the Device 2. As shown by reference number 915, the Device 1 may indicate for the Device 2 to share input for perception area B, perception area C, and perception area D. As shown by reference number 920, the Device 1 enters area A and updates perception using its own input. As shown by reference number 925, the Device 2 enters area A and does not share any input associated with perception area A. As shown by reference number 930, the Device 1 enters perception area B and does not use any input from Device 1 regarding perception area B for building the perception information. As shown by reference number 935, the Device 2 enters perception area B and shares input regarding perception area B with the Device 1. As shown by reference number 940, the Device 1 updates the perception information using the input from the Device 2. As shown by reference number 945, the Device 1 shares the updated perception information with the Device 2.

As indicated above, FIG. 9 is provided as an example. Other examples may differ from what is described with regard to FIG. 9.

FIG. 10 is a diagram illustrating an example process 1000 performed, for example, at a first device or an apparatus of a first device, in accordance with the present disclosure. Example process 1000 is an example where the apparatus or the first device (e.g., first device 505) performs operations associated with extended reality perception information sharing.

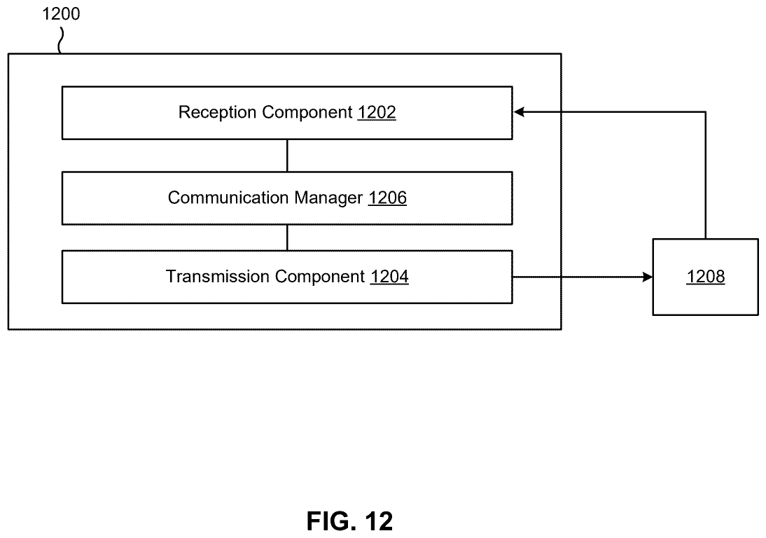

As shown in FIG. 10, in some aspects, process 1000 may include performing an initial setup process between the first device and a second device, wherein the initial setup process indicates that the first device and the second device are to share perception information associated with an extended reality application (block 1010). For example, the first device (e.g., using communication manager 1206, depicted in FIG. 12) may perform an initial setup process between the first device and a second device, wherein the initial setup process indicates that the first device and the second device are to share perception information associated with an extended reality application, as described above.

As further shown in FIG. 10, in some aspects, process 1000 may include transmitting, to at least one of the second device or a server that communicates with the first device and the second device, one or more first perception information inputs associated with the first device (block 1020). For example, the first device (e.g., using transmission component 1204 and/or communication manager 1206, depicted in FIG. 12) may transmit, to at least one of the second device or a server that communicates with the first device and the second device, one or more first perception information inputs associated with the first device, as described above.

As further shown in FIG. 10, in some aspects, process 1000 may include receiving, from at least one of the second device or the server, one or more perception information outputs, wherein the one or more perception information outputs include combined perception information that is based at least in part on the one or more first perception information inputs and on one or more second perception information inputs associated with the second device (block 1030). For example, the first device (e.g., using reception component 1202 and/or communication manager 1206, depicted in FIG. 12) may receive, from at least one of the second device or the server, one or more perception information outputs, wherein the one or more perception information outputs include combined perception information that is based at least in part on the one or more first perception information inputs and on one or more second perception information inputs associated with the second device, as described above.

Process 1000 may include additional aspects, such as any single aspect or any combination of aspects described below and/or in connection with one or more other processes described elsewhere herein.

In a first aspect, process 1000 includes interacting with the extended reality application using the one or more perception information outputs.

In a second aspect, alone or in combination with the first aspect, the perception information includes environment information that indicates one or more characteristics of an environment associated with the first device and the second device, object information that indicates one or more objects located in the environment, lighting information that indicates one or more lighting characteristics of the environment, positioning information that indicates a positioning characteristic of at least one of the first device or the second device, or user information that indicates at least one of a characteristic of a user of the first device or a characteristic of a user of the second device.

In a third aspect, alone or in combination with one or more of the first and second aspects, process 1000 includes receiving, from a perception component associated with the server, a request for VPS session information associated with a VPS session between the first device and the second device, transmitting, to the perception component, a VPS session identifier associated with the VPS session, and receiving, from the perception component, a sharing indication that indicates for the first device to share perception information with the second device, wherein transmitting the one or more first perception information inputs comprises transmitting the one or more first perception information inputs to the perception component in accordance with the sharing indication.

In a fourth aspect, alone or in combination with one or more of the first through third aspects, transmitting the one or more first perception information inputs to the perception component comprises transmitting the one or more first perception information inputs to the perception component in accordance with a characteristic of the first device and a characteristic of the second device being aligned with a coordinate system of the VPS session.

In a fifth aspect, alone or in combination with one or more of the first through fourth aspects, process 1000 includes transmitting, to a cloud component associated with the server, a perception service discovery message associated with sharing the perception information between the first device and the second device, receiving, from the cloud component, an indication that perception service sharing is permitted between the first device and the second device, receiving, from the cloud component, a request for VPS session information associated with a VPS session between the first device and the second device, transmitting, to the cloud component, a VPS session identifier associated with the VPS session, and receiving, from the cloud component, a sharing indication that indicates for the first device to share perception information with the second device, wherein transmitting the one or more first perception information inputs comprises transmitting the one or more first perception information inputs to the cloud component in accordance with the sharing indication.

In a sixth aspect, alone or in combination with one or more of the first through fifth aspects, the initial setup process between the first device and the second device is an initial setup process between a component of the first device and a component of the second device.

In a seventh aspect, alone or in combination with one or more of the first through sixth aspects, process 1000 includes transmitting, by a VPS connector of the first device, to a VPS server between the VPS connector of the first device and a VPS connector of the second device, a request to coordinate the initial setup process between the first device and the second device, determining, by the component of the first device, to share the perception information between the first device and the second device using the VPS server, and transmitting, by the VPS connector of the first device to the VPS server, an indication to share the perception information between the first device and the second device using the VPS server, wherein transmitting the one or more first perception information inputs comprises transmitting the one or more first perception information inputs to a perception component associated with the server that communicates with the first device and the second device.

In an eighth aspect, alone or in combination with one or more of the first through seventh aspects, process 1000 includes transmitting, by the component of the first device to the component of the second device, a request to coordinate the initial setup process between the first device and the second device, determining, by the component of the first device, to share the perception information between the first device and the second device using a VPS server, and transmitting, by the component of the first device to the component of the second device, an indication to share the perception information between the first device and the second device using the VPS server, wherein transmitting the one or more first perception information inputs comprises transmitting the one or more first perception information inputs to a perception component associated with the server that communicates with the first device and the second device.

In a ninth aspect, alone or in combination with one or more of the first through eighth aspects, process 1000 includes transmitting, by a VPS connector of the first device, to a VPS server between the VPS connector of the first device and a VPS connector of the second device, a request to coordinate the initial setup process between the first device and the second device, determining, by the component of the first device, to share the perception information between the first device and the second device using the VPS server, and transmitting, by the component of the first device to the component of the second device, an indication to share the perception information between the first device and the second device using the VPS server, wherein transmitting the one or more first perception information inputs comprises transmitting, by the component of the first device to the component of the second device, the one or more first perception information inputs.

In a tenth aspect, alone or in combination with one or more of the first through ninth aspects, process 1000 includes transmitting, by the component of the first device to the component of the second device, a request to coordinate the initial setup process between the first device and the second device, determining, by the component of the first device, to share the perception information between the first device and the second device using a VPS server, and transmitting, by the component of the first device to the component of the second device, an indication to share the perception information between the first device and the second device using the VPS server, wherein transmitting the one or more first perception information inputs comprises transmitting, by the component of the first device to the component of the second device, the one or more first perception information inputs.

In an eleventh aspect, alone or in combination with one or more of the first through tenth aspects, process 1000 includes receiving, from the server or the second device, one or more instructions associated with sharing the perception information between the first device and the second device, wherein transmitting the one or more first perception information inputs comprises transmitting the one or more first perception information inputs in accordance with the one or more instructions.

In a twelfth aspect, alone or in combination with one or more of the first through eleventh aspects, the one or more instructions include timing information for transmitting the perception information, configuration information for transmitting the perception information, or one or more key performance indicators associated with the one or more first perception information inputs.

In a thirteenth aspect, alone or in combination with one or more of the first through twelfth aspects, process 1000 includes transmitting, to the second device, one or more instructions associated with sharing the perception information between the first device and the second device.

In a fourteenth aspect, alone or in combination with one or more of the first through thirteenth aspects, the one or more instructions include timing information for transmitting the perception information, configuration information for transmitting the perception information, or one or more key performance indicators associated with the one or more first perception information inputs.

In a fifteenth aspect, alone or in combination with one or more of the first through fourteenth aspects, process 1000 includes receiving, from the server or the second device, a request for one or more key performance indicators associated with sharing the perception information.

In a sixteenth aspect, alone or in combination with one or more of the first through fifteenth aspects, the one or more key performance indicators include a battery level of the first device, a position of the first device, a pose of the first device, or a video capability of the first device.

In a seventeenth aspect, alone or in combination with one or more of the first through sixteenth aspects, process 1000 includes receiving, from the server or the second device, an indication for the first device to send the one or more first perception information inputs in accordance with one or more conditions being satisfied.

In an eighteenth aspect, alone or in combination with one or more of the first through seventeenth aspects, the one or more conditions include the first device being in a certain location of an environment, the first device being in a certain pose, a camera of the first device detecting one or more scenes, the first device moving at a certain speed, or the first device supporting a certain resolution.

In a nineteenth aspect, alone or in combination with one or more of the first through eighteenth aspects, process 1000 includes receiving, from the server or the second device, configuration information for transmitting the one or more first perception information inputs.

In a twentieth aspect, alone or in combination with one or more of the first through nineteenth aspects, the configuration information includes a resolution for the one or more first perception information inputs, a quality for the one or more first perception information inputs, a frame rate for the one or more first perception information inputs, one or more parameters for the one or more first perception information inputs, or a description of one or more objects to be detected.

In a twenty-first aspect, alone or in combination with one or more of the first through twentieth aspects, process 1000 includes transmitting, to the second device, a request for one or more key performance indicators associated with sharing the perception information.

In a twenty-second aspect, alone or in combination with one or more of the first through twenty-first aspects, the one or more key performance indicators include a battery level of the first device, a position of the first device, a pose of the first device, or a video capability of the first device.

In a twenty-third aspect, alone or in combination with one or more of the first through twenty-second aspects, process 1000 includes transmitting, to the second device, an indication for the second device to send the one or more second perception information inputs in accordance with one or more conditions being satisfied.

In a twenty-fourth aspect, alone or in combination with one or more of the first through twenty-third aspects, the one or more conditions include the second device being in a certain location of an environment, the second device being in a certain pose, a camera of the second device detecting one or more scenes, the second device moving at a certain speed, or the second device supporting a certain resolution.

In a twenty-fifth aspect, alone or in combination with one or more of the first through twenty-fourth aspects, process 1000 includes transmitting, to the second device, configuration information for transmitting the one or more second perception information inputs.

In a twenty-sixth aspect, alone or in combination with one or more of the first through twenty-fifth aspects, the configuration information includes a resolution for the one or more second perception information inputs, a quality for the one or more second perception information inputs, a frame rate for the one or more second perception information inputs, one or more parameters for the one or more second perception information inputs, or a description of one or more objects to be detected.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a server or an apparatus of a server, in accordance with the present disclosure. Example process 1100 is an example where the apparatus or the server (e.g., server 515) performs operations associated with extended reality perception information sharing.

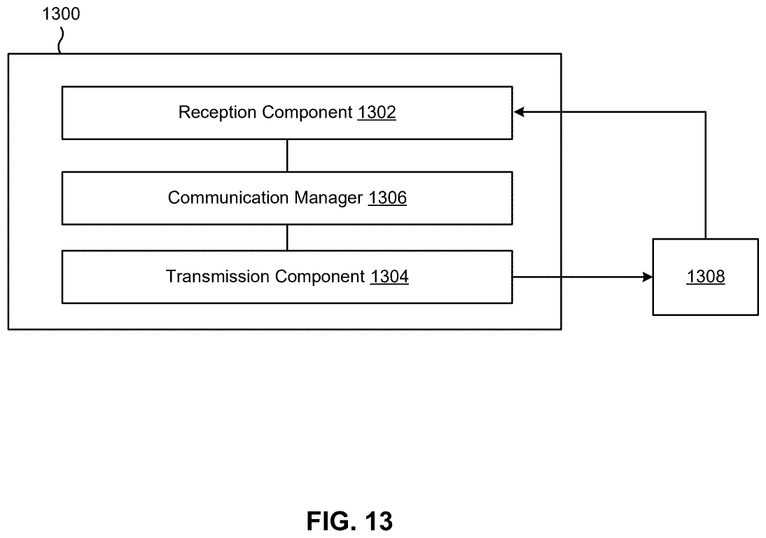

As shown in FIG. 11, in some aspects, process 1100 may include receiving, from a first device, one or more first perception information inputs associated with a first extended reality application operating on the first device (block 1110). For example, the server (e.g., using reception component 1302 and/or communication manager 1306, depicted in FIG. 13) may receive, from a first device, one or more first perception information inputs associated with a first extended reality application operating on the first device, as described above.

As further shown in FIG. 11, in some aspects, process 1100 may include receiving, from a second device, one or more second perception information inputs associated with a second extended reality application operating on the second device (block 1120). For example, the server (e.g., using reception component 1302 and/or communication manager 1306, depicted in FIG. 13) may receive, from a second device, one or more second perception information inputs associated with a second extended reality application operating on the second device, as described above.

As further shown in FIG. 11, in some aspects, process 1100 may include generating combined perception information that is based at least in part on the one or more first perception information inputs and the one or more second perception information inputs (block 1130). For example, the server (e.g., using communication manager 1306, depicted in FIG. 13) may generate combined perception information that is based at least in part on the one or more first perception information inputs and the one or more second perception information inputs, as described above.

As further shown in FIG. 11, in some aspects, process 1100 may include transmitting, to at least one of the first device or the second device, the combined perception information (block 1140). For example, the server (e.g., using transmission component 1304 and/or communication manager 1306, depicted in FIG. 13) may transmit, to at least one of the first device or the second device, the combined perception information, as described above.

Process 1100 may include additional aspects, such as any single aspect or any combination of aspects described below and/or in connection with one or more other processes described elsewhere herein.

In a first aspect, the one or more first perception information inputs include environment information that indicates one or more characteristics of an environment associated with the first device and the second device, object information that indicates one or more objects located in the environment, lighting information that indicates one or more lighting characteristics of the environment, first positioning information that indicates a positioning characteristic of the first device, or first user information that indicates a characteristic of a user of the first device, and the one or more second perception information inputs include the environment information, the object information, the lighting information, second positioning information that indicates a positioning characteristic of the second device, or second user information that indicates a characteristic of a user of the second device.

In a second aspect, alone or in combination with the first aspect, process 1100 includes transmitting, by a perception component associated with the server, a request for VPS session information associated with a VPS session between the first device and the second device, receiving, from at least one of the first device or the second device, a VPS session identifier associated with the VPS session, and transmitting, to the first device, a sharing indication that indicates for the first device to share perception information with the second device.

In a third aspect, alone or in combination with one or more of the first and second aspects, receiving the one or more first perception information inputs comprises receiving the one or more first perception information inputs in accordance with a characteristic of the first device and a characteristic of the second device being aligned with a coordinate system of the VPS session.

In a fourth aspect, alone or in combination with one or more of the first through third aspects, process 1100 includes receiving, by a cloud component associated with the server, a perception service discovery message associated with sharing the perception information between the first device and the second device, transmitting, to at least one of the first device or the second device, an indication that perception service sharing is permitted between the first device and the second device, transmitting, to at least one of the first device or the second device, a request for VPS session information associated with a VPS session between the first device and the second device, receiving, by the cloud component, a VPS session identifier associated with the VPS session, and transmitting, to the first device, a sharing indication that indicates for the first device to share perception information with the second device.

In a fifth aspect, alone or in combination with one or more of the first through fourth aspects, an initial setup process between the first device and the second device is an initial setup process between a component of the first device and a component of the second device.

In a sixth aspect, alone or in combination with one or more of the first through fifth aspects, process 1100 includes transmitting, to the first device, one or more instructions associated with sharing the perception information between the first device and the second device.

In a seventh aspect, alone or in combination with one or more of the first through sixth aspects, the one or more instructions include timing information for transmitting the perception information, configuration information for transmitting the perception information, or one or more key performance indicators associated with the one or more first perception information inputs.

In an eighth aspect, alone or in combination with one or more of the first through seventh aspects, process 1100 includes transmitting, to the first device, a request for one or more key performance indicators associated with sharing the perception information.

In a ninth aspect, alone or in combination with one or more of the first through eighth aspects, the one or more key performance indicators include a battery level of the first device, a position of the first device, a pose of the first device, or a video capability of the first device.

In a tenth aspect, alone or in combination with one or more of the first through ninth aspects, process 1100 includes transmitting, to the first device, an indication for the first device to send the one or more first perception information inputs in accordance with one or more conditions being satisfied.

In an eleventh aspect, alone or in combination with one or more of the first through tenth aspects, the one or more conditions include the first device being in a certain location of an environment, the first device being in a certain pose, a camera of the first device detecting one or more scenes, the first device moving at a certain speed, or the first device supporting a certain resolution.

In a twelfth aspect, alone or in combination with one or more of the first through eleventh aspects, process 1100 includes transmitting, to the first device, configuration information for transmitting the one or more first perception information inputs.

In a thirteenth aspect, alone or in combination with one or more of the first through twelfth aspects, the configuration information includes a resolution for the one or more first perception information inputs, a quality for the one or more first perception information inputs, a frame rate for the one or more first perception information inputs, one or more parameters for the one or more first perception information inputs, or a description of one or more objects to be detected.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a first device, or a first device may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 140 described in connection with FIG. 1) of the first device.

In some aspects, the apparatus 1200 may be configured to perform one or more operations described herein in connection with FIGS. 5-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the first device described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the first device described above in connection with FIG. 1, such as a radio, one or more RF chains, one or more transceivers, or one or more modems, each of which may in turn be coupled with one or more antennas of the first device.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the first device described above in connection with FIG. 1, such as a radio, one or more RF chains, one or more transceivers, or one or more modems, each of which may in turn be coupled with one or more antennas of the first device described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The communication manager 1206 may perform an initial setup process between the first device and a second device, wherein the initial setup process indicates that the first device and the second device are to share perception information associated with an extended reality application. The transmission component 1204 may transmit, to at least one of the second device or a server that communicates with the first device and the second device, one or more first perception information inputs associated with the first device. The reception component 1202 may receive, from at least one of the second device or the server, one or more perception information outputs, wherein the one or more perception information outputs include combined perception information that is based at least in part on the one or more first perception information inputs and on one or more second perception information inputs associated with the second device.

The communication manager 1206 may interact with the extended reality application using the one or more perception information outputs. The reception component 1202 may receive, from a perception component associated with the server, a request for VPS session information associated with a VPS session between the first device and the second device. The transmission component 1204 may transmit, to the perception component, a VPS session identifier associated with the VPS session. The reception component 1202 may receive, from the perception component, a sharing indication that indicates for the first device to share perception information with the second device wherein transmitting the one or more first perception information inputs comprises transmitting the one or more first perception information inputs to the perception component in accordance with the sharing indication. The transmission component 1204 may transmit, to a cloud component associated with the server, a perception service discovery message associated with sharing the perception information between the first device and the second device.

The reception component 1202 may receive, from the cloud component, an indication that perception service sharing is permitted between the first device and the second device. The reception component 1202 may receive, from the cloud component, a request for VPS session information associated with a VPS session between the first device and the second device. The transmission component 1204 may transmit, to the cloud component, a VPS session identifier associated with the VPS session. The reception component 1202 may receive, from the cloud component, a sharing indication that indicates for the first device to share perception information with the second device wherein transmitting the one or more first perception information inputs comprises transmitting the one or more first perception information inputs to the cloud component in accordance with the sharing indication.

The transmission component 1204 may transmit, to a VPS server between a VPS connector of the first device and a VPS connector of the second device, a request to coordinate the initial setup process between the first device and the second device. The communication manager 1206 may determine to share the perception information between the first device and the second device using the VPS server. The transmission component 1204 may transmit an indication to share the perception information between the first device and the second device using the VPS server wherein transmitting the one or more first perception information inputs comprises transmitting the one or more first perception information inputs to a perception component associated with the server that communicates with the first device and the second device. The transmission component 1204 may transmit a request to coordinate the initial setup process between the first device and the second device. The communication manager 1206 may determine to share the perception information between the first device and the second device using a VPS server. The transmission component 1204 may transmit an indication to share the perception information between the first device and the second device using the VPS server wherein transmitting the one or more first perception information inputs comprises transmitting the one or more first perception information inputs to a perception component associated with the server that communicates with the first device and the second device.

The transmission component 1204 may transmit, to a VPS server between a VPS connector of the first device and a VPS connector of the second device, a request to coordinate the initial setup process between the first device and the second device. The communication manager 1206 may determine to share the perception information between the first device and the second device using the VPS server. The transmission component 1204 may transmit an indication to share the perception information between the first device and the second device using the VPS server wherein transmitting the one or more first perception information inputs comprises transmitting, by the component of the first device to the component of the second device, the one or more first perception information inputs. The transmission component 1204 may transmit a request to coordinate the initial setup process between the first device and the second device. The communication manager 1206 may determine to share the perception information between the first device and the second device using a VPS server. The transmission component 1204 may transmit an indication to share the perception information between the first device and the second device using the VPS server, wherein transmitting the one or more first perception information inputs comprises transmitting, by the component of the first device to the component of the second device, the one or more first perception information inputs.

The reception component 1202 may receive, from the server or the second device, one or more instructions associated with sharing the perception information between the first device and the second device, wherein transmitting the one or more first perception information inputs comprises transmitting the one or more first perception information inputs in accordance with the one or more instructions. The transmission component 1204 may transmit, to the second device, one or more instructions associated with sharing the perception information between the first device and the second device.

The reception component 1202 may receive, from the server or the second device, a request for one or more key performance indicators associated with sharing the perception information. The reception component 1202 may receive, from the server or the second device, an indication for the first device to send the one or more first perception information inputs in accordance with one or more conditions being satisfied. The reception component 1202 may receive, from the server or the second device, configuration information for transmitting the one or more first perception information inputs. The transmission component 1204 may transmit, to the second device, a request for one or more key performance indicators associated with sharing the perception information. The transmission component 1204 may transmit, to the second device, an indication for the second device to send the one or more second perception information inputs in accordance with one or more conditions being satisfied. The transmission component 1204 may transmit, to the second device, configuration information for transmitting the one or more second perception information inputs.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a server, or a server may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 155 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 145 described in connection with FIG. 1) of the server.

In some aspects, the apparatus 1300 may be configured to perform one or more operations described herein in connection with FIGS. 5-9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the server described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the server described above in connection with FIG. 1, such as a radio, one or more RF chains, one or more transceivers, or one or more modems, each of which may in turn be coupled with one or more antennas of the server.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the server described above in connection with FIG. 1, such as a radio, one or more RF chains, one or more transceivers, or one or more modems, each of which may in turn be coupled with one or more antennas of the server described in connection with FIG. 1. In some aspects, the transmission component 1304 may be co-located with the reception component 1302.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive, from a first device, one or more first perception information inputs associated with a first extended reality application operating on the first device. The reception component 1302 may receive, from a second device, one or more second perception information inputs associated with a second extended reality application operating on the second device. The communication manager 1306 may generate combined perception information that is based at least in part on the one or more first perception information inputs and the one or more second perception information inputs. The transmission component 1304 may transmit, to at least one of the first device or the second device, the combined perception information.

The transmission component 1304 may transmit a request for VPS session information associated with a VPS session between the first device and the second device. The reception component 1302 may receive, from at least one of the first device or the second device, a VPS session identifier associated with the VPS session. The transmission component 1304 may transmit, to the first device, a sharing indication that indicates for the first device to share perception information with the second device. The reception component 1302 may receive a perception service discovery message associated with sharing the perception information between the first device and the second device. The transmission component 1304 may transmit, to at least one of the first device or the second device, an indication that perception service sharing is permitted between the first device and the second device. The transmission component 1304 may transmit, to at least one of the first device or the second device, a request for VPS session information associated with a VPS session between the first device and the second device.

The reception component 1302 may receive a VPS session identifier associated with the VPS session. The transmission component 1304 may transmit, to the first device, a sharing indication that indicates for the first device to share perception information with the second device. The transmission component 1304 may transmit, to the first device, one or more instructions associated with sharing the perception information between the first device and the second device. The transmission component 1304 may transmit, to the first device, a request for one or more key performance indicators associated with sharing the perception information. The transmission component 1304 may transmit, to the first device, an indication for the first device to send the one or more first perception information inputs in accordance with one or more conditions being satisfied. The transmission component 1304 may transmit, to the first device, configuration information for transmitting the one or more first perception information inputs.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a first device, comprising: performing an initial setup process between the first device and a second device, wherein the initial setup process indicates that the first device and the second device are to share perception information associated with an extended reality application; transmitting, to at least one of the second device or a server that communicates with the first device and the second device, one or more first perception information inputs associated with the first device; and receiving, from at least one of the second device or the server, one or more perception information outputs, wherein the one or more perception information outputs include combined perception information that is based at least in part on the one or more first perception information inputs and on one or more second perception information inputs associated with the second device.

Aspect 2: The method of Aspect 1, further comprising interacting with the extended reality application using the one or more perception information outputs.

Aspect 3: The method of any of Aspects 1-2, wherein the perception information includes environment information that indicates one or more characteristics of an environment associated with the first device and the second device, object information that indicates one or more objects located in the environment, lighting information that indicates one or more lighting characteristics of the environment, positioning information that indicates a positioning characteristic of at least one of the first device or the second device, or user information that indicates at least one of a characteristic of a user of the first device or a characteristic of a user of the second device.

Aspect 4: The method of any of Aspects 1-3, further comprising: receiving, from a perception component associated with the server, a request for visual positioning system (VPS) session information associated with a VPS session between the first device and the second device; transmitting, to the perception component, a VPS session identifier associated with the VPS session; and receiving, from the perception component, a sharing indication that indicates for the first device to share perception information with the second device, wherein transmitting the one or more first perception information inputs comprises transmitting the one or more first perception information inputs to the perception component in accordance with the sharing indication.

Aspect 5: The method of Aspect 4, wherein transmitting the one or more first perception information inputs to the perception component comprises transmitting the one or more first perception information inputs to the perception component in accordance with a characteristic of the first device and a characteristic of the second device being aligned with a coordinate system of the VPS session.

Aspect 6: The method of any of Aspects 1-5, further comprising: transmitting, to a cloud component associated with the server, a perception service discovery message associated with sharing the perception information between the first device and the second device; receiving, from the cloud component, an indication that perception service sharing is permitted between the first device and the second device; receiving, from the cloud component, a request for visual positioning system (VPS) session information associated with a VPS session between the first device and the second device; transmitting, to the cloud component, a VPS session identifier associated with the VPS session; and receiving, from the cloud component, a sharing indication that indicates for the first device to share perception information with the second device, wherein transmitting the one or more first perception information inputs comprises transmitting the one or more first perception information inputs to the cloud component in accordance with the sharing indication.

Aspect 7: The method of any of Aspects 1-6, wherein the initial setup process between the first device and the second device is an initial setup process between a component of the first device and a component of the second device.

Aspect 8: The method of Aspect 7, further comprising: transmitting, by a visual positioning system (VPS) connector of the first device, to a VPS server between a VPS connector of the first device and a VPS connector of the second device, a request to coordinate the initial setup process between the first device and the second device; determining, by the component of the first device, to share the perception information between the first device and the second device using the VPS server; and transmitting, by the VPS connector of the first device to the VPS server, an indication to share the perception information between the first device and the second device using the VPS server, wherein transmitting the one or more first perception information inputs comprises transmitting the one or more first perception information inputs to a perception component associated with the server that communicates with the first device and the second device.

Aspect 9: The method of Aspect 7, further comprising: transmitting, by the component of the first device to the component of the second device, a request to coordinate the initial setup process between the first device and the second device; determining, by the component of the first device, to share the perception information between the first device and the second device using a visual positioning system (VPS) server; and transmitting, by the component of the first device to the component of the second device, an indication to share the perception information between the first device and the second device using the VPS server, wherein transmitting the one or more first perception information inputs comprises transmitting the one or more first perception information inputs to a perception component associated with the server that communicates with the first device and the second device.

Aspect 10: The method of Aspect 7, further comprising: transmitting, by a visual positioning system (VPS) connector of the first device, to a VPS server between a VPS connector of the first device and a VPS connector of the second device, a request to coordinate the initial setup process between the first device and the second device; determining, by the component of the first device, to share the perception information between the first device and the second device using the VPS server; and transmitting, by the component of the first device to the component of the second device, an indication to share the perception information between the first device and the second device using the VPS server, wherein transmitting the one or more first perception information inputs comprises transmitting, by the component of the first device to the component of the second device, the one or more first perception information inputs.

Aspect 11: The method of Aspect 7, further comprising: transmitting, by the component of the first device to the component of the second device, a request to coordinate the initial setup process between the first device and the second device; determining, by the component of the first device, to share the perception information between the first device and the second device using a visual positioning system (VPS) server; and transmitting, by the component of the first device to the component of the second device, an indication to share the perception information between the first device and the second device using the VPS server, wherein transmitting the one or more first perception information inputs comprises transmitting, by the component of the first device to the component of the second device, the one or more first perception information inputs.

Aspect 12: The method of any of Aspects 1-11, further comprising receiving, from the server or the second device, one or more instructions associated with sharing the perception information between the first device and the second device, wherein transmitting the one or more first perception information inputs comprises transmitting the one or more first perception information inputs in accordance with the one or more instructions.

Aspect 13: The method of Aspect 12, wherein the one or more instructions include timing information for transmitting the perception information, configuration information for transmitting the perception information, or one or more key performance indicators associated with the one or more first perception information inputs.

Aspect 14: The method of any of Aspects 1-13, further comprising transmitting, to the second device, one or more instructions associated with sharing the perception information between the first device and the second device.

Aspect 15: The method of Aspect 14, wherein the one or more instructions include timing information for transmitting the perception information, configuration information for transmitting the perception information, or one or more key performance indicators associated with the one or more first perception information inputs.

Aspect 16: The method of any of Aspects 1-15, further comprising receiving, from the server or the second device, a request for one or more key performance indicators associated with sharing the perception information.

Aspect 17: The method of Aspect 16, wherein the one or more key performance indicators include a battery level of the first device, a position of the first device, a pose of the first device, or a video capability of the first device.

Aspect 18: The method of Aspect 16, further comprising receiving, from the server or the second device, an indication for the first device to send the one or more first perception information inputs in accordance with one or more conditions being satisfied.

Aspect 19: The method of Aspect 18, wherein the one or more conditions include the first device being in a certain location of an environment, the first device being in a certain pose, a camera of the first device detecting one or more scenes, the first device moving at a certain speed, or the first device supporting a certain resolution.

Aspect 20: The method of Aspect 18, further comprising receiving, from the server or the second device, configuration information for transmitting the one or more first perception information inputs.

Aspect 21: The method of Aspect 20, wherein the configuration information includes a resolution for the one or more first perception information inputs, a quality for the one or more first perception information inputs, a frame rate for the one or more first perception information inputs, one or more parameters for the one or more first perception information inputs, or a description of one or more objects to be detected.

Aspect 22: The method of any of Aspects 1-21, further comprising transmitting, to the second device, a request for one or more key performance indicators associated with sharing the perception information.

Aspect 23: The method of Aspect 22, wherein the one or more key performance indicators include a battery level of the first device, a position of the first device, a pose of the first device, or a video capability of the first device.

Aspect 24: The method of Aspect 22, further comprising transmitting, to the second device, an indication for the second device to send the one or more second perception information inputs in accordance with one or more conditions being satisfied.

Aspect 25: The method of Aspect 24, wherein the one or more conditions include the second device being in a certain location of an environment, the second device being in a certain pose, a camera of the second device detecting one or more scenes, the second device moving at a certain speed, or the second device supporting a certain resolution.

Aspect 26: The method of Aspect 24, further comprising transmitting, to the second device, configuration information for transmitting the one or more second perception information inputs.

Aspect 27: The method of Aspect 26, wherein the configuration information includes a resolution for the one or more second perception information inputs, a quality for the one or more second perception information inputs, a frame rate for the one or more second perception information inputs, one or more parameters for the one or more second perception information inputs, or a description of one or more objects to be detected.

Aspect 28: A method of wireless communication performed by a server, comprising: receiving, from a first device, one or more first perception information inputs associated with a first extended reality application operating on the first device; receiving, from a second device, one or more second perception information inputs associated with a second extended reality application operating on the second device; generating combined perception information that is based at least in part on the one or more first perception information inputs and the one or more second perception information inputs; and transmitting, to at least one of the first device or the second device, the combined perception information.

Aspect 29: The method of Aspect 28, wherein the one or more first perception information inputs include environment information that indicates one or more characteristics of an environment associated with the first device and the second device, object information that indicates one or more objects located in the environment, lighting information that indicates one or more lighting characteristics of the environment, first positioning information that indicates a positioning characteristic of the first device, or first user information that indicates a characteristic of a user of the first device, and wherein the one or more second perception information inputs include the environment information, the object information, the lighting information, second positioning information that indicates a positioning characteristic of the second device, or second user information that indicates a characteristic of a user of the second device.

Aspect 30: The method of any of Aspects 28-29, further comprising: transmitting, by a perception component associated with the server, a request for visual positioning system (VPS) session information associated with a VPS session between the first device and the second device; receiving, from at least one of the first device or the second device, a VPS session identifier associated with the VPS session; and transmitting, to the first device, a sharing indication that indicates for the first device to share perception information with the second device.

Aspect 31: The method of Aspect 30, wherein receiving the one or more first perception information inputs comprises receiving the one or more first perception information inputs in accordance with a characteristic of the first device and a characteristic of the second device being aligned with a coordinate system of the VPS session.

Aspect 32: The method of any of Aspects 28-31, further comprising: receiving, by a cloud component associated with the server, a perception service discovery message associated with sharing the perception information between the first device and the second device; transmitting, to at least one of the first device or the second device, an indication that perception service sharing is permitted between the first device and the second device; transmitting, to at least one of the first device or the second device, a request for visual positioning system (VPS) session information associated with a VPS session between the first device and the second device; receiving, by the cloud component, a VPS session identifier associated with the VPS session; and transmitting, to the first device, a sharing indication that indicates for the first device to share perception information with the second device.

Aspect 33: The method of any of Aspects 28-32, wherein an initial setup process between the first device and the second device is an initial setup process between a component of the first device and a component of the second device.

Aspect 34: The method of any of Aspects 28-33, further comprising transmitting, to the first device, one or more instructions associated with sharing the perception information between the first device and the second device.

Aspect 35: The method of Aspect 34, wherein the one or more instructions include timing information for transmitting the perception information, configuration information for transmitting the perception information, or one or more key performance indicators associated with the one or more first perception information inputs.

Aspect 36: The method of any of Aspects 28-35, further comprising transmitting, to the first device, a request for one or more key performance indicators associated with sharing the perception information.

Aspect 37: The method of Aspect 36, wherein the one or more key performance indicators include a battery level of the first device, a position of the first device, a pose of the first device, or a video capability of the first device.

Aspect 38: The method of Aspect 36, further comprising transmitting, to the first device, an indication for the first device to send the one or more first perception information inputs in accordance with one or more conditions being satisfied.

Aspect 39: The method of Aspect 38, wherein the one or more conditions include the first device being in a certain location of an environment, the first device being in a certain pose, a camera of the first device detecting one or more scenes, the first device moving at a certain speed, or the first device supporting a certain resolution.

Aspect 40: The method of Aspect 38, further comprising transmitting, to the first device, configuration information for transmitting the one or more first perception information inputs.

Aspect 41: The method of Aspect 40, wherein the configuration information includes a resolution for the one or more first perception information inputs, a quality for the one or more first perception information inputs, a frame rate for the one or more first perception information inputs, one or more parameters for the one or more first perception information inputs, or a description of one or more objects to be detected.

Aspect 42: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-41.

Aspect 43: An apparatus for wireless communication at a device, the apparatus comprising one or more memories and one or more processors coupled to the one or more memories, the one or more processors configured to cause the device to perform the method of one or more of Aspects 1-41.

Aspect 44: An apparatus for wireless communication, the apparatus comprising at least one means for performing the method of one or more of Aspects 1-41.

Aspect 45: A non-transitory computer-readable medium storing code for wireless communication, the code comprising instructions executable by one or more processors to perform the method of one or more of Aspects 1-41.

Aspect 46: A non-transitory computer-readable medium storing a set of instructions for wireless communication, the set of instructions comprising one or more instructions that, when executed by one or more processors of a device, cause the device to perform the method of one or more of Aspects 1-41.

Aspect 47: A device for wireless communication, the device comprising a processing system that includes one or more processors and one or more memories coupled with the one or more processors, the processing system configured to cause the device to perform the method of one or more of Aspects 1-41.

Aspect 48: An apparatus for wireless communication at a device, the apparatus comprising one or more memories and one or more processors coupled to the one or more memories, the one or more processors individually or collectively configured to cause the device to perform the method of one or more of Aspects 1-41.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a first device, comprising:
one or more memories; and
one or more processors, coupled to the one or more memories, configured to cause the first device to:
perform an initial setup process between the first device and a second device, wherein the initial setup process indicates that the first device and the second device are to share perception information associated with an extended reality application;
transmit, to at least one of the second device or a server that communicates with the first device and the second device, one or more first perception information inputs associated with the first device; and
receive, from at least one of the second device or the server, one or more perception information outputs, wherein the one or more perception information outputs include combined perception information that is based at least in part on the one or more first perception information inputs and on one or more second perception information inputs associated with the second device.

2. The apparatus of claim 1, wherein the one or more processors are further configured to cause the first device to interact with the extended reality application using the one or more perception information outputs.

3. The apparatus of claim 1, wherein the perception information includes environment information that indicates one or more characteristics of an environment associated with the first device and the second device, object information that indicates one or more objects located in the environment, lighting information that indicates one or more lighting characteristics of the environment, positioning information that indicates a positioning characteristic of at least one of the first device or the second device, or user information that indicates at least one of a characteristic of a user of the first device or a characteristic of a user of the second device.

4. The apparatus of claim 1, wherein the one or more processors are further configured to cause the first device to:
receive, from a perception component associated with the server, a request for visual positioning system (VPS) session information associated with a VPS session between the first device and the second device;
transmit, to the perception component, a VPS session identifier associated with the VPS session; and
receive, from the perception component, a sharing indication that indicates for the first device to share perception information with the second device,
wherein the one or more processors, to cause the first device to transmit the one or more first perception information inputs, are configured to cause the first device to transmit the one or more first perception information inputs to the perception component in accordance with the sharing indication.

5. The apparatus of claim 4, wherein the one or more processors, to cause the first device to transmit the one or more first perception information inputs to the perception component, are configured to cause the first device to transmit the one or more first perception information inputs to the perception component in accordance with a characteristic of the first device and a characteristic of the second device being aligned with a coordinate system of the VPS session.

6. The apparatus of claim 1, wherein the one or more processors are further configured to cause the first device to:
transmit, to a cloud component associated with the server, a perception service discovery message associated with sharing the perception information between the first device and the second device;
receive, from the cloud component, an indication that perception service sharing is permitted between the first device and the second device;
receive, from the cloud component, a request for visual positioning system (VPS) session information associated with a VPS session between the first device and the second device;
transmit, to the cloud component, a VPS session identifier associated with the VPS session; and
receive, from the cloud component, a sharing indication that indicates for the first device to share perception information with the second device,
wherein the one or more processors, to cause the first device to transmit the one or more first perception information inputs, are configured to cause the first device to transmit the one or more first perception information inputs to the cloud component in accordance with the sharing indication.

7. The apparatus of claim 1, wherein the initial setup process between the first device and the second device is an initial setup process between a component of the first device and a component of the second device.

8. The apparatus of claim 7, wherein the one or more processors are further configured to cause the first device to:
transmit to a VPS server between a VPS connector of the first device and a VPS connector of the second device, a request to coordinate the initial setup process between the first device and the second device;
determine to share the perception information between the first device and the second device using the VPS server; and
transmit an indication to share the perception information between the first device and the second device using the VPS server,
wherein the one or more processors, to cause the first device to transmit the one or more first perception information inputs, are configured to cause the first device to transmit the one or more first perception information inputs to a perception component associated with the server that communicates with the first device and the second device.

9. The apparatus of claim 7, wherein the one or more processors are further configured to cause the first device to:
transmit a request to coordinate the initial setup process between the first device and the second device;
determine to share the perception information between the first device and the second device using a visual positioning system (VPS) server; and
transmit an indication to share the perception information between the first device and the second device using the VPS server,
wherein the one or more processors, to cause the first device to transmit the one or more first perception information inputs, are configured to cause the first device to transmit the one or more first perception information inputs to a perception component associated with the server that communicates with the first device and the second device.

10. The apparatus of claim 7, wherein the one or more processors are further configured to cause the first device to:
transmit to a VPS server between a VPS connector of the first device and a VPS connector of the second device, a request to coordinate the initial setup process between the first device and the second device;
determine to share the perception information between the first device and the second device using the VPS server; and
transmit an indication to share the perception information between the first device and the second device using the VPS server,
wherein the one or more processors, to cause the first device to transmit the one or more first perception information inputs, are configured to cause the first device to transmit, by the component of the first device to the component of the second device, the one or more first perception information inputs.

11. The apparatus of claim 7, wherein the one or more processors are further configured to cause the first device to:
transmit a request to coordinate the initial setup process between the first device and the second device;
determine to share the perception information between the first device and the second device using a visual positioning system (VPS) server; and
transmit an indication to share the perception information between the first device and the second device using the VPS server,
wherein the one or more processors, to cause the first device to transmit the one or more first perception information inputs, are configured to cause the first device to transmit, by the component of the first device to the component of the second device, the one or more first perception information inputs.

12. The apparatus of claim 1, wherein the one or more processors are further configured to cause the first device to receive, from the server or the second device, one or more instructions associated with sharing the perception information between the first device and the second device, wherein transmitting the one or more first perception information inputs comprises transmitting the one or more first perception information inputs in accordance with the one or more instructions.

13. The apparatus of claim 12, wherein the one or more instructions include timing information for transmitting the perception information, configuration information for transmitting the perception information, or one or more key performance indicators associated with the one or more first perception information inputs.

14. The apparatus of claim 1, wherein the one or more processors are further configured to cause the first device to transmit, to the second device, one or more instructions associated with sharing the perception information between the first device and the second device.

15. The apparatus of claim 14, wherein the one or more instructions include information for transmitting the perception information, configuration information for transmitting the perception information, or one or more key performance indicators associated with the one or more first perception information inputs.

16. The apparatus of claim 1, wherein the one or more processors are further configured to cause the first device to receive, from the server or the second device, a request for one or more key performance indicators associated with sharing the perception information.

17. The apparatus of claim 1, wherein the one or more processors are further configured to cause the first device to transmit, to the second device, a request for one or more key performance indicators associated with sharing the perception information.

18. An apparatus for wireless communication at a server, comprising:
one or more memories; and
one or more processors, coupled to the one or more memories, configured to cause the server to:
receive, from a first device, one or more first perception information inputs associated with a first extended reality application operating on the first device;
receive, from a second device, one or more second perception information inputs associated with a second extended reality application operating on the second device;
generate combined perception information that is based at least in part on the one or more first perception information inputs and the one or more second perception information inputs; and
transmit, to at least one of the first device or the second device, the combined perception information.

19. The apparatus of claim 18, wherein the one or more first perception information inputs include environment information that indicates one or more characteristics of an environment associated with the first device and the second device, object information that indicates one or more objects located in the environment, lighting information that indicates one or more lighting characteristics of the environment, first positioning information that indicates a positioning characteristic of the first device, or first user information that indicates a characteristic of a user of the first device, and wherein the one or more second perception information inputs include the environment information, the object information, the lighting information, second positioning information that indicates a positioning characteristic of the second device, or second user information that indicates a characteristic of a user of the second device.

20. A method of wireless communication performed by a first device, comprising:
performing an initial setup process between the first device and a second device, wherein the initial setup process indicates that the first device and the second device are to share perception information associated with an extended reality application;
transmitting, to at least one of the second device or a server that communicates with the first device and the second device, one or more first perception information inputs associated with the first device; and
receiving, from at least one of the second device or the server, one or more perception information outputs, wherein the one or more perception information outputs include combined perception information that is based at least in part on the one or more first perception information inputs and on one or more second perception information inputs associated with the second device.
